(19) United States
(12) Patent Application Publication
(10) Pub. No.: US 2025/0254582 A1
(43) Pub. Date: Aug. 7, 2025

(54) METHOD AND APPARATUS FOR REGISTERING UE IN TELECOMMUNICATION NETWORK

(71) Applicant: SAMSUNG ELECTRONICS CO., LTD., Suwon-si, Gyeonggi-do (KR)

(72) Inventors: Neha SHARMA, Bangalore (IN); Vikalp MANDAWARIA, Bangalore (IN); Shiva Souhith GANTHA, Bangalore (IN)

(21) Appl. No.: 18/858,261

(22) PCT Filed: Apr. 20, 2023
(86) PCT No.: PCT/KR2023/005399

§ 371 Date: Oct. 18, 2024

(30) Foreign Application Priority Data
Apr. 20, 2022 (IN) 202241023223
Apr. 8, 2023 (IN) 202241023223
Apr. 8, 2023 (IN) 202342026319

(51) Int. Cl. H04W 36/08; H04W 36/00; H04W 60/04; H04W 76/20

(52) U.S. Cl. CPC H04W 36/08; H04W 36/0058; H04W 36/008355; H04W 60/04; H04W 76/20

(57) ABSTRACT

The disclosure relates to a 5G or 6G communication system for supporting a higher data transmission rate. A method for registering a UE (124) in a telecommunication network (500) by a CMF apparatus (154). The method includes receiving a registration request from the UE through a network apparatus (2200). The CMF apparatus is selected by the network apparatus upon receiving a registration request message from the UE. Further, the method includes sending an authentication request message and a UE capability enquiry request message to the UE through the network apparatus. Further, the method includes receiving an authentication response message and a UE capability response message comprising UE capability from the UE through the network apparatus. Further, the method includes sending a security mode command to the UE through the network apparatus. Further, the method includes receiving a security mode complete response from the UE through network apparatus. Further, the method includes sending a registration accept message to the UE through network apparatus.

### TECHNICAL FIELD

The present disclosure relates to a telecommunication network, and more particularly to a method and a system for registering a User Equipment (UE) and handling handover in the telecommunication network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Currently, there are needs to enhance registering UE and handling handover in wireless communication system.

### Solution to Problem

Accordingly, the embodiment herein is to provide a method for registering a UE in a telecommunication network. The method includes receiving by a Connection management function (CMF) apparatus, a registration request from the UE through a network apparatus. The CMF apparatus is selected by the network apparatus upon receiving a registration request message from the UE. Further, the method includes sending, by the CMF apparatus, an authentication request message and a UE capability enquiry request message to the UE through the network apparatus. Further, the method includes receiving, by the CMF apparatus, an authentication response message and a UE capability response message comprising UE capability from the UE through the network apparatus. Further, the method includes sending, by the CMF apparatus, a security mode command to the UE through the network apparatus. Further, the method includes receiving, by the CMF apparatus, a security mode complete response from the UE through the network apparatus. Further, the method includes sending, by the CMF apparatus, a registration accept message to the UE through the network apparatus.

In an embodiment, sending, by the CMF apparatus, the authentication request message includes selecting, by the CMF apparatus, a NF based on at least one of a SUPI and a SUCI, invoking, by the CMF apparatus, a NF for authenticating the UE, and selecting, by the CMF apparatus, a NF for authenticating the UE.

In an embodiment, the network apparatus is one of a hub, a CMD, and a switch and act as a single anchor point for all UE messages.

In an embodiment, the network apparatus is located at independently in the telecommunication network. In another embodiment, the network apparatus is located in NF at a core network in the telecommunication network. In another embodiment, the network apparatus is located in a Distributed Unit (DU) at a Radio Access Network (RAN) in the telecommunication network.

In an embodiment, the CMF apparatus is a NF apparatus comprising a combination of a RRC node, an AMF node, and a SMF node in the telecommunication network. In an embodiment, the CMF apparatus handles at least one of all RRC operations, NAS operations, connection establishment operations, registration procedure, handover operations, radio link control operations and Medium access control operations.

In an embodiment, the registration accept message includes a 5G Global Unique Temporary Identifier (5G-GUTI), a registration area for the UE, a mobility restrictions for the UE, a Protocol Data Unit (PDU) session status of the UE, allowed NSSAI for the UE, mapping of the allowed NSSAI for the UE, configured NSSAI for a serving PLMN associated with the UE, mapping of configured NSSAI for the UE, a periodic registration update timer, a Local Area Data Network (LADN) information and accepted Mobile Initiated Connection Only (MICO) mode, an IP Multimedia Subsystem (IMS) voice over PS session supported indication, an emergency service support indicator, accepted Discontinuous reception (DRX) parameters, Network support of interworking, and a network slicing subscription change indication.

Accordingly, the embodiment herein is to provide a method for registering a UE in a telecommunication network. The method includes sending, by the UE, a registration request message to a network apparatus. Further, the method includes receiving, by the UE, an authentication request from a CMF apparatus through the network apparatus. The CMF apparatus is selected by the network apparatus upon receiving the registration request message from the UE. Further, the method includes performing, by the UE, an authentication process and sending an authentication response message to CMF apparatus selected by the network apparatus. Further, the method includes sending, by the UE, a UE capability response message comprising UE capability to the CMF apparatus through the network apparatus. Further, the method includes receiving, by the UE, a security mode command from the CMF apparatus through the network apparatus. Further, the method includes sending, by the UE, a security mode complete response to the CMF apparatus through the network apparatus. Further, the method includes receiving, by the UE, a registration accept message from the CMF apparatus through the network apparatus.

In an embodiment, the registration request message includes at least one of a registration type, a SUCI, a 5G-GUTI, a PEI, a last visited TAI, security parameters, requested NSSAI for the UE, mapping of NSSAI for the UE, radio capability update of the UE, MM Core network capability of the UE, a PDU session status associated with the UE, a list of PDU Sessions to be activated for the UE, a follow on request, a MICO mode preference of the UE, a requested DRX parameters of the UE, a policy container of the UE, and a UE Context.

Accordingly, the embodiment herein is to provide a method for registering a UE in a telecommunication network. The method includes receiving, by a network apparatus, a registration request message from the UE. Further, the method includes selecting, by the network apparatus, a CMF apparatus based on a SIB information. Further, the method includes forwarding, by the network apparatus, the registration request message to the selected CMF apparatus. Further, the method includes controlling, by the network apparatus, exchange of messages between the UE and the selected CMF apparatus for registration of the UE in the telecommunication network.

In an embodiment, forwarding, by the network apparatus, the registration request message to the selected CMF apparatus includes determining, by the network apparatus, whether the UE is in a connected state, and forwarding, by the network apparatus, the registration request message to the selected CMF apparatus based on a Service based interface (SBI) connection of the UE.

In an embodiment, the SIB information comprises at least one of a type of service, a NF identifier (ID), and a cell ID with type of service.

Accordingly, the embodiment herein is to provide a CMF apparatus for registering a UE in a telecommunication network. The CMF apparatus includes a memory, a processor, and a combination of a RRC node, an AMF node, and a SMF node in the telecommunication network. The CMF apparatus handles at least one of all RRC operations, NAS operations, connection establishment operations, registration procedure, handover operations, radio link control operations and Medium access control operations. The CMF apparatus includes a registration controller communicatively coupled to the memory and the processor. The registration controller receives a registration request from the UE through a network apparatus. The CMF apparatus is selected by the network apparatus upon receiving a registration request message from the UE. Further, the registration controller sends an authentication request message and a UE capability enquiry request message to a UE through the network apparatus. Further, the registration controller receives an authentication response message and a UE capability response message comprising UE capability from the UE through the network apparatus. Further, the registration controller sends a security mode command to the UE through the network apparatus. Further, the registration controller receives a security mode complete response from the UE through the network apparatus. Further, the registration controller sends a registration accept message to the UE through the network apparatus.

Accordingly, the embodiment herein is to provide a UE in a telecommunication network. The UE includes a registration controller, communicatively coupled to a memory and a processor. The registration controller sends a registration request message to a network apparatus and receives an authentication request from a CMF apparatus through the network apparatus. The CMF apparatus is selected by the network apparatus upon receiving the registration request message from the UE. Further, the registration controller performs an authentication process and sending an authentication response message CMF apparatus selected by the network apparatus. Further, the registration controller sends a UE capability response message comprising UE capability to the CMF apparatus through the network apparatus. Further, the registration controller receives a security mode command from the CMF apparatus through the network apparatus. Further, the registration controller sends a security mode complete response to the CMF apparatus through the network apparatus. Further, the registration controller receives a registration accept message from the CMF apparatus through the network apparatus.

Accordingly, the embodiment herein is to provide a network apparatus for registering a UE in a telecommunication network. The network apparatus includes a registration controller communicatively coupled to a memory and a processor. The registration controller receives a registration request message from a UE and selects a CMF apparatus based on a SIB information. Further, the registration controller forwards the registration request message to the selected CMF apparatus. Further, the registration controller controls exchange of messages between the UE and the selected CMF apparatus for registration of the UE in the telecommunication network.

Accordingly, the embodiment herein is to provide a method for handling handover in a telecommunication network. The method includes receiving, by a source gNB-DU, a measurement report from a UE in the telecommunication network. Further, the method includes sending, by the source gNB-DU, a RRC message including the measurement report received from the UE to a source CMF apparatus. Further, the method includes receiving, by the source gNB-DU, a RRC Reconfiguration message indicating handover requirement from the source CMF apparatus. Further, the method includes sending by the source gNB-DU, the RRC Reconfiguration message to the UE for initiating the handover.

In an embodiment, receiving, by the source gNB-DU, the RRC Reconfiguration message indicating the handover requirement from the source CMF apparatus includes receiving, by the source gNB-DU, a UE context modification request message comprising the RRC Reconfiguration message from the CMF apparatus, and sending, by the source gNB-DU, a UE context modification response message to the source CMF apparatus indicating that the RRC Reconfiguration message is sent to the UE.

In an embodiment, sending, by the source CMF apparatus, the UE context modification request message comprising the RRC Reconfiguration message to the source gNB-DU includes sending, by the source CMF apparatus, a UE context setup request to an eSMF, receiving, by the source CMF apparatus, a UE context setup response from the eSMF (120a) based on the UE context setup request message, and sending, by the source CMF apparatus, the UE context modification request message comprising the RRC Reconfiguration message to the source gNB-DU based on the UE context setup response.

In an embodiment, the RRC message is a UL RRC transfer message. In an embodiment, the exchange of messages between the UE and the source CMF apparatus is controlled through a network apparatus.

In an embodiment, the source CMF apparatus is a NF apparatus comprising a combination of a RRC node, an AMF node, and a SMF node in the telecommunication network.

In an embodiment, the source CMF apparatus handles at least one of all RRC operations, NAS operations, connection establishment operations, registration procedure, handover operations, radio link control operations and Medium access control operations.

Accordingly, the embodiment herein is to provide a method for handling handover in a telecommunication network. The method includes receiving, by a source CMF apparatus, a RRC message including a measurement report received from a UE from a source gNB-DU. Further, the method includes determining by the source CMF apparatus, whether the handover is required for the UE based on the received measurement report of the UE. Further, the method includes sending, by the source CMF apparatus, a RRC Reconfiguration message indicating handover requirement to the source gNB-DU when the source CMF apparatus determines that the handover is required for the UE.

In an embodiment, sending, by the source CMF apparatus, the RRC Reconfiguration message indicating the handover requirement to the source gNB-DU includes sending, by the source CMF apparatus, a UE context modification request message comprising the RRC Reconfiguration message to the source gNB-DU, and receiving, by the source CMF apparatus, a UE context modification response message from the source gNB-DU indicating that the RRC Reconfiguration message is sent to the UE.

Accordingly, the embodiment herein is to provide a source gNB for handling handover in a telecommunication network. The source gNB includes a handover controller communicatively coupled to a memory, a processor, and a DU. The handover controller receives a measurement report from a UE in the telecommunication network. Further, the handover controller sends a RRC message including the measurement report received from the UE to a source CMF apparatus. Further, the handover controller receives a RRC Reconfiguration message indicating handover requirement from the source CMF apparatus. Further, the handover controller sends the RRC Reconfiguration message to the UE for initiating the handover.

Accordingly, the embodiment herein is to provide a source CMF apparatus for handling handover in a telecommunication network. The source CMF apparatus includes a handover controller communicatively coupled to a memory, a processor, and a DU. The handover controller receives a RRC message including a measurement report received from a UE from a source gNB-DU. Further, the handover controller determines whether the handover is required for the UE based on the received measurement report of the UE. Further, the handover controller sends a RRC Reconfiguration message indicating handover requirement to the source gNB-DU when the source CMF apparatus determines that the handover is required for the UE.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

According to various embodiments of the disclosure, registering UE and handling handover in wireless communication system can be efficiently enhanced.

### BRIEF DESCRIPTION OF DRAWINGS

The method and the system for registering the UE and handling the handover are illustrated in the accompanying drawings, throughout which like reference letters indicate corresponding parts in the various figures. The embodiments herein will be better understood from the following description with reference to the drawings, in which:

FIG. 1 illustrating a scenario of service-based interfaces is used within a Control Plane (CP), according to the prior arts;

FIG. 2 illustrates a 5G architecture, according to the prior arts;

FIG. 3 illustrates a 6G network architecture, according to the embodiments as disclosed herein;

FIG. 4 illustrates a 6G network architecture reflecting how hops are reduced, according to the embodiments as disclosed herein;

FIG. 5 illustrates a RAN-CN converged architecture, according to the embodiments as disclosed herein;

FIG. 6 is a sequence diagram illustrating a registration call flow procedure for registering a UE in a telecommunication network, according to the embodiments as disclosed herein;

FIG. 7 illustrates registration management states which are used in the UE and a CMF apparatus that reflect a registration status of the UE in a selected PLMN, according to the embodiments as disclosed herein;

FIG. 8 illustrates registration management states at the UE, according to the embodiments as disclosed herein;

FIG. 9 illustrates a scenario of possible handover mechanism in the 6G network architecture, according to the embodiments as disclosed herein;

FIG. 10 illustrates a scenario of possibility for different types of handover in the 6G network architecture, according to the embodiments as disclosed herein;

FIG. 11 illustrates an example sequence diagram of an intra DU handover procedure, according to the embodiments as disclosed herein;

FIG. 12 illustrates an example sequence diagram of an inter gNB or an inter DU mobility procedure, according to the embodiments as disclosed herein;

FIG. 13 illustrates an example sequence diagram of an inter gNB handover-inter NF mobility during a handover preparation phase, according to the embodiments as disclosed herein;

FIG. 14 illustrates an example sequence diagram of an inter gNB handover-inter NF mobility during a handover execution phase, according to the embodiments as disclosed herein;

FIG. 15 illustrating a sequence diagram of intra gNB handover with respect to the hub change procedure, according to the embodiments as disclosed herein;

FIG. 16 illustrating impacts on various layers or modules for various handover procedure, according to the embodiments as disclosed herein;

FIG. 17 shows various hardware components of the UE, according to the embodiments as disclosed herein;

FIG. 18 shows various hardware components of the CMF apparatus, according to the embodiments as disclosed herein;

FIG. 19 shows various hardware components of a network apparatus, according to the embodiments as disclosed herein;

FIG. 20 shows various hardware components of a source gNB, according to the embodiments as disclosed herein;

FIG. 21 is a flow chart illustrating a method, implemented by the CMF apparatus, for registering the UE in the telecommunication network, according to the embodiments as disclosed herein;

FIG. 22 is a flow chart illustrating a method, implemented by the UE, for registering the UE in the telecommunication network, according to the embodiments as disclosed herein;

FIG. 23 is a flow chart illustrating a method, implemented by the network apparatus, for registering the UE in the telecommunication network, according to the embodiments as disclosed herein;

FIG. 24 is a flow chart illustrating a method, implemented by a source gNB-DU, for handling handover in the telecommunication network, according to the embodiments as disclosed herein;

FIG. 25 is a flow chart illustrating a method, implemented by a source CMF apparatus, for handling handover in the telecommunication network, according to the embodiments as disclosed herein.

FIG. 26 illustrates a block diagram of a user equipment (UE) according to an embodiment of the disclosure;

FIG. 27 illustrates a block diagram of a base station (BS) according to an embodiment of the disclosure. and

FIG. 28 illustrates a block diagram of a network entity according to an embodiment of the disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### BEST MODE FOR CARRYING OUT THE INVENTION

Several broadband wireless technologies have been developed to meet the growing number of broadband subscribers for providing better applications and services. A second generation (2G) wireless communication system has been developed to provide voice services while ensuring the mobility of users. A third generation (3G) wireless communication system supports not only the voice services but also a data service. Further, a fourth generation (4G) wireless communication system has been developed to provide high-speed data service. But, the 4G wireless communication system suffers from a lack of resources to meet the growing demand for high-speed data services. The lack of resources problem is solved by a deployment of a fifth generation (5G) wireless communication system to meet the ever-growing demand for high-speed data services. Furthermore, the 5G wireless communication system provides ultra-reliability and supports low latency applications.

A 5G system architecture is based on a service-based architecture (SBA). As per 3rd Generation Partnership Project technical specification (3GPP TS) 23.501, the 5G system architecture is defined as service-based and an interaction in the 5G system architecture among network functions is represented in following two ways.
1. A service-based representation, where network functions (e.g. Access and Mobility Management Function (AMF) (aka “AMF node”)) within a Control Plane enables other authorized network functions to access the services. The representation includes point-to-point reference points where necessary.
2. The point-to-point reference points show the interaction exists between the NF services in the network functions described by point-to-point reference point (e.g. N11 or the like) between any two network functions (e.g. AMF node and a Session Management Function (SMF) (aka “SMF node”)).

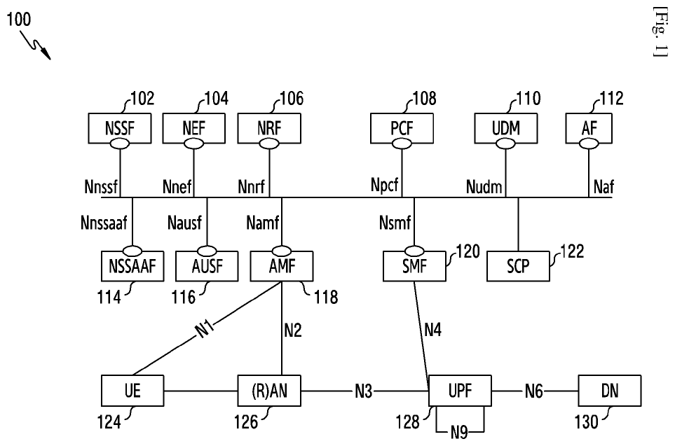

FIG. 1 illustrating a scenario of service-based interfaces is used within the CP, according to the prior arts. A 5G service based core network architecture brins more scalability and flexibility as any Network function (NF) node can interact with any other node. The 5G system architecture leverages service-based interactions between CP Network Functions. A set of NFs provide services to other authorized NFs to access their services through a service based interface (SBI). A NF service is one type of capability exposed by a NF (i.e., NF service producer) to other authorized NF (i.e., NF service consumer). The NF service may support one or more NF service operation(s). The NFs may offer different functionalities, so as to provide different NF services. Each of the NF services offered by the network function is self-contained, acted upon and managed independently from other NF services offered by the same network function (e.g. for scaling, healing).

The service based interface represents how the set of services is provided or exposed by a given NF. The service based interface is the interface where the NF service operations are invoked. The following Control Plane interfaces within the 5G core network (CN) specified in 3GPP TS 23.501 are defined as service based interfaces:—Namf, Nsmf, Nudm, Nnrf, Nnssf, Nausf, Nnef, Nsmsf, Nudr, Npcf, N5g-eir, Nlmf.

The 5G system architecture consists of the following network functions (NF):
a) Authentication Server Function (AUSF) (116),
b) AMF node (118),
c) Data Network (DN) (130), e.g. operator services, Internet access or 3rd party services,
d) Unstructured Data Storage Function (UDSF),
e) Network Exposure Function (NEF) (104),
f) Network Repository Function (NRF) (106),
g) Network Slice Specific Authentication and Authorization Function (NSSAAF),
h) Network Slice Selection Function (NSSF) (102),
i) Policy Control Function (PCF) (108),
j) Session Management Function (SMF) node (120),
k) Unified Data Management (UDM) (110),
l) Unified Data Repository (UDR) (134),
m) User Plane Function (UPF) (128),
n) UE radio Capability Management Function (UCMF),
o) Application Function (AF) (112),
p) User Equipment (UE) (124),
q) (Radio) Access Network ((R) AN) (126),
r) 5G-Equipment Identity Register (5G-EIR),
s) Network Data Analytics Function (NWDAF) (132),
t) Charging Function (CHF),
u) NSSAAF (114), and
v) service control point (SCP) (122).

Some of the NFs (e.g., SCP, UCMF or the like) are not shown in the FIG. 1.

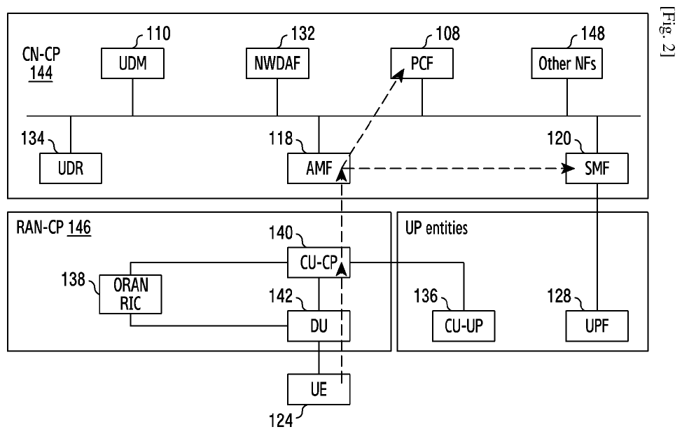

FIG. 2 illustrates a 5G architecture, according to the prior arts. A 5G core is based on the service based interface but the RAN (126) to the core network is still point to point interaction. Due to a network function virtualization, the RAN (126) as we all as the core network may be at same location but still the RAN (126) can only interact with single core network entity i.e. AMF node (118). The RAN (126) as well as the AMF node (118) becomes anchor for all UE control messages and each message has to pass through the network entities which are inefficient as it impacts overall control plane latency. The arrangement also leads to increased hops (e.g., delay, computational overhead or the like) for the control message delivery.

The 5G architecture increases a number of hops and eventually increased the control plane latency. Thus, results in leading to increase overhead at network nodes and control procedure completion time due to involvement of multiple nodes. The point to point communication also leads to redundant functionalities in the RAN (126) and a CN control plane and use the complex protocols like NGAP to communicate between two nodes. There is need to design more flexible and simple network function for a sixth generation (6G) which can provide the degree of freedom for network function placement due to cloudification and virtualization of network functions.

It is desired to address the above mentioned disadvantages or other short comings or at least provide a useful alternative.

The principal object of the embodiments herein is to provide a method and a system for registering a UE and handling handover in a telecommunication network.

Another object of the embodiments herein is to design of procedures for a service based network architecture in a 6G network.

Another objective the embodiments herein is to design a registration procedure for end to end based or a 6G service based network architecture.

Another objective the embodiments herein is to define possible handover procedures for end to end based or a 6G service based network architecture.

Another objective the embodiments herein is to design multiple handover procedures for end to end based or 6G service based network architecture.

Another objective the embodiments herein is to provide a signalling mechanism for registration and handover procedures for end to end based or 6G service based network architecture.

Another objective the embodiments herein is to provide a SIB structure to support NF selection.

Another objective the embodiments herein is to define state machines at a UE and a network for a registration state.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method for registering a UE in a telecommunication network. The method includes receiving by a CMF apparatus, a registration request from the UE through a network apparatus. The CMF apparatus is selected by the network apparatus upon receiving a registration request message from the UE. Further, the method includes sending, by the CMF apparatus, an authentication request message and a UE capability enquiry request message to the UE through the network apparatus. Further, the method includes receiving, by the CMF apparatus, an authentication response message and a UE capability response message comprising UE capability from the UE through the network apparatus. Further, the method includes sending, by the CMF apparatus, a security mode command to the UE through the network apparatus. Further, the method includes receiving, by the CMF apparatus, a security mode complete response from the UE through the network apparatus. Further, the method includes sending, by the CMF apparatus, a registration accept message to the UE through the network apparatus.

The proposed method can be used to design a procedure for service based network architecture in a 6G network, where any network node communicates with any other network node being at a RAN or core network function in the 6G network. The design enables a single anchor for a UE to exchange control signalling with the 6G network.

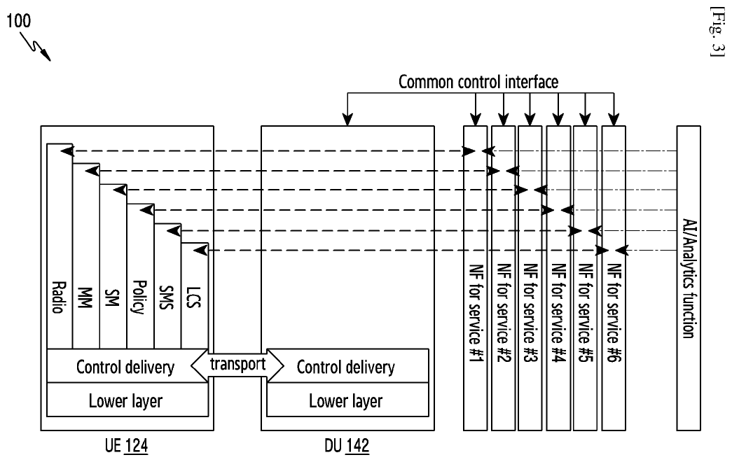

Referring now to the drawings and more particularly to FIGS. 3 through 25, where similar reference characters denote corresponding features consistently throughout the figures, there are shown preferred embodiments.

FIG. 3 illustrates the 6G network architecture, according to the embodiments as disclosed herein. FIG. 4 illustrates a 6G network architecture reflecting how hops can be reduced, according to the embodiments as disclosed herein.

In the 6G network architecture, the RAN (126) acts as service based RAN as a result the RAN (126) can interact with any NF node. All the NF nodes are controlled by the hub (156) or a switch or a CMD (152) which is single anchor point for all UE messages. The hub (156) can be independent module or located at specific NF or located along with a DU (142) or can be kept at various NF. All control message trans-missions between the UE (124) and hub (156) are managed through a single layer. The UE's control message is parsed at the hub (156) and then the hub (156) delivered directly to a destination node. There is SBI interface between the HUB (156) and rest of NF nodes and the SBI connectivity may use HTTP/2 types or equivalent protocols. The multiple NF can belong to different services like connection management, Session Management, Handovers, service request, etc.

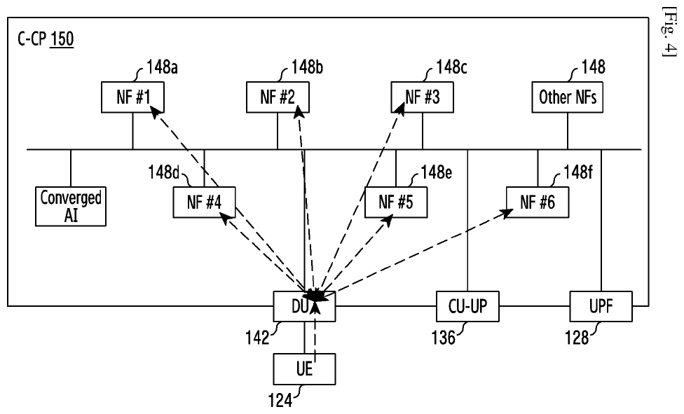

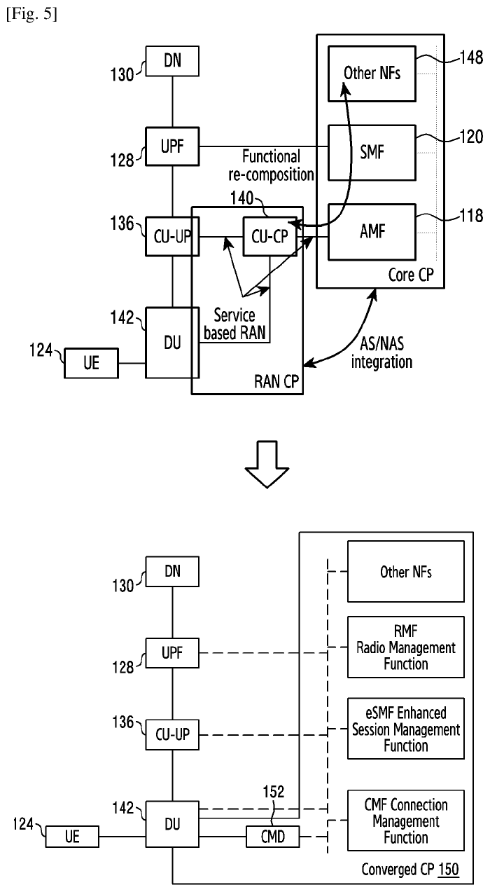

FIG. 5 illustrates a RAN-CN converged architecture, according to the embodiments as disclosed herein. One of the possible implementation for these NF could be that where the RAN (126) and the AMF node (118) are combined together and new module is created say NF1 (148a) or the CMF apparatus (154). The CMF apparatus (154) is handling all RRC as well as exiting NAS related functionality. The CMF apparatus (154) handles connection establishment, registration procedure, handover, handling of radio link control and Medium access control and other basic NAS functionalities. The eSMF (120a) handles all session management and bearer related functionalities, similarly other NF (148, 148c-148f) handles specific services related to various procedure. The HUB (156)/CMD (command management distribution) module (152) can directly interact with any Network function which can decrease the overall network latency.

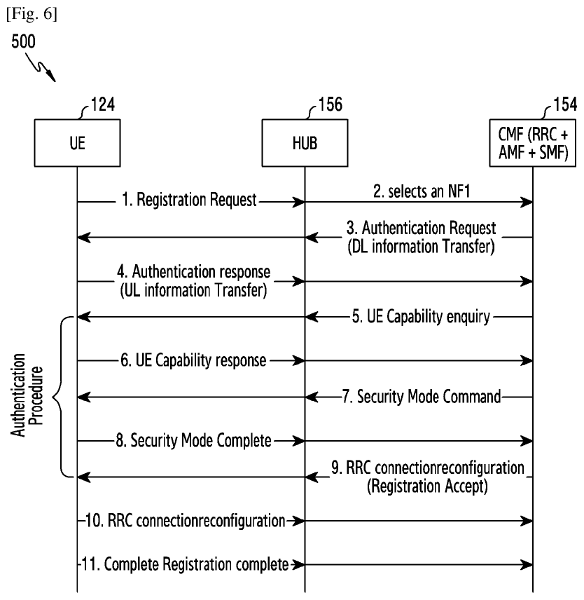

FIG. 6 is a sequence diagram illustrating a registration call flow procedure for registering a UE (124) in a telecommunication network (500), according to the embodiments as disclosed herein.

In an amendment, the CMF apparatus (154) is connection management function having both RRC and AMF functionality. So initiation and termination of messages changes as a result processing and signalling mechanism also changes. Further, it is assume that a DU and HUB (156) are located at a same location. The first NF (i.e., NF1) (148a) module has few AS and NAS functionality i.e. RAN (126) and AMF node (118) or combination of any other existing NF module like SMF node (120) or PCF (108) or so. The various steps involved is describe below:

At step 1, the UE (124) to the Hub (156): The UE (124) sends the registration request to the CMF apparatus (154) through the hub (156). The registration request includes AN parameters, Registration Request (Registration type, SUCI or 5G-GUTI or PEI, last visited TAI (if available), security parameters, Requested NSSAI, (Mapping Of Requested NSSAI), UE Radio Capability Update, UE MM Core Network Capability, PDU Session status, List Of PDU Sessions To Be Activated, Follow on request, MICO mode preference, Requested DRX parameters) and UE Policy Container (the list of PSIs), and UE Context request).

At step 2, The hub (156) selects an NF1 (148a) based on type of service. When the UE (124) is in a CM-CONNECTED state, the HUB (156) forwards a registration request message to the NF1 (148a) based on the SBI connection of the UE (124). As the RAN (126) and the AMF node (118) have been integrated to the NF1 (148a), there is no need to perform any AMF node selection. Further, the NF1 (148a) may be supporting separate functions so that the UE (124) needs to select the right NF1 (148a) as per the service requirement. It may be assumed that there can be multiple instances of NF1 (148a) and each or few of NF1 (148a) can support different services. The selection of NF1 (148a) can be done through the SIB where it can inform the each cell along with type of service. Once the hub (156) selects the NF1 (148a), the hub (156) can forward the message to the NF1 (148a). The SIB can share the cell ID along with type of service or NF ID in any SI message. The SIB maps the cell ID with type of service and/or NF ID. The information can be used by the hub (156) to select the particular NF entity. The SIB structure is described below and the SIB structure can be part of any SI message −3×331

```
  System information Block {
  List of cell ID number of entries
{
  Cell ID
  Type of service
  NF ID
  }
  {
  Cell ID
  Type of service
  NF ID
  }
```

At step 3, the NF1 (148a) may decide to initiate the UE authentication by invoking a NFx (like AUSF) (116). In that case, the NF1 (148a) selects an NFx based on a SUPI or a SUCI, as described in TS 23.501. Upon request from the NF1 (148a), the NFx executes the authentication of the UE (124). The authentication is performed as described in TS 33.501. The NFx selects the NFy (e.g., UDM) (110) as described in TS 23.501, clause 6.3.8 and gets the authentication data from the NFy.

The CMF apparatus (154) sends the authentication request to the hub (156) and then the hub (156) forwards the same to the UE (124).

At step 4, the UE (124), on receiving the same, performs authentication and sends an authentication response to the CMF apparatus (154) through the hub (156). At step 5, CMF apparatus (154) initiates the UE capability enquiry, and the UE (124), on receiving the same, send the UE capability response to the CMF apparatus (154) at step 6.

At step 7, upon receiving the capability response, the CMF apparatus (154) send a security mode command to the UE (124). In this case, the CMF apparatus (154) sends the security keys which can be NF specific or PDCP layer keys or common keys which the UE (124) can use. At step 8, the UE (124) send a security mode complete to the CMF apparatus (154).

At step 9, the CMF apparatus (154) sends a registration accept message to the UE (124) indicating that the registration request has been accepted. The registration accept includes the 5G-GUTI, the registration area, the mobility restrictions, the PDU session status, the allowed NSSAI, (i.e., Mapping Of Allowed NSSAI), a configured NSSAI for the Serving PLMN, mapping Of configured NSSAI, a periodic registration update timer, the LADN information and accepted MICO mode, an IMS Voice over PS session supported Indication, an emergency service support indicator, an accepted DRX parameters, network support of interworking without N26, and the network slicing subscription change indication. The allowed NSSAI for the access type for the UE (124) is included in the SBI message carrying the registration accept message. At step 10, The UE (124) sends a RRC connection reconfiguration to the CMF apparatus (154). At step 11, the UE (124) sends a registration complete message to the CMF apparatus (154).

FIG. 7 illustrates registration management states (700) which are used in the UE (124) and the CMF apparatus (154) that reflect the registration status of the UE (124) in a selected PLMN, according to the embodiments as disclosed herein. There can be multiple RM states which are used in the UE (124) and the CMF apparatus (154) that reflect the registration status of the UE (124) in the selected PLMN:
Idle and RM-DEREGISTERED: the UE (124) is not registered with the telecommunication network (500) but camped on the cell. The UE context in the CMF apparatus (154) holds no valid location or routing information for the UE (124) so that the UE (124) is not reachable by the CMF apparatus (154). Further, some parts of UE context may still be stored in the UE (124) and the CMF apparatus (154) e.g. to avoid running an authentication procedure during every Registration procedure.
Idle and RM-REGISTERED: the UE (124) is registered with the telecommunication network (500). In the RM-REGISTERED state, the UE (124) can receive services that require registration with the network.
Connected and RM-REGISTERED: the UE (124) is registered with the telecommunication network (500). In the Connected and RM-REGISTERED state, the UE (124) can receive services that require registration with the network and stores the AS/RAN (126)/CMF apparatus (154) or any other NF context.
Inactive and RM-REGISTERED: the UE (124) is registered with the telecommunication network (500). In the Inactive and RM-REGISTERED state, the UE (124) can receive services that require registration with the network and stores the UE inactive AS/RAN (126)/CMF apparatus (154) or any other NF context.

FIG. 8 illustrates registration management states (800) at the UE (124), according to the embodiments as disclosed herein.

In the Idle and RM-DEREGISTERED state, the UE (124):
a) attempts to register with the selected PLMN using the initial registration procedure when the UE (124) needs to receive service that requires registration.
b) remains in the idle RM-DEREGISTERED state when receiving the Registration

Reject upon the initial registration
c) enters connected/idle RM-REGISTERED state upon receiving a registration accept

When the UE RM state in the CMF apparatus (154) is idle RM-DEREGISTERED, the CMF apparatus (154):
a) when applicable, accepts the initial registration of the UE (124) by sending the registration accept to the UE (124) and enters the connected RM-REGISTERED state for the UE (124).
b) when applicable, rejects the Initial Registration of the UE by sending the registration reject to the UE (124).
c) when applicable, accepts the initial registration of the UE (124) by sending the registration accept to the UE (124) and enters idle RM-REGISTERED state for the UE (124) when the context is released.

In the connected and RM-REGISTERED state, the UE (124):
a. performs a mobility registration update procedure when the current TAI of the serving cell (refer 3GPP TS 37.340) is not in the list of TAIs that the UE (124) has received from the telecommunication network (500) in order to maintain the registration and enable the AMF node (118) to page the UE (124).
b. performs a periodic registration update procedure triggered by expiration of the periodic update timer to notify the network that the UE (124) is still active.
c. performs a mobility registration update procedure to update the capability information or to re-negotiate protocol parameters with the network;
b) performs a deregistration procedure (see TS 23.502 clause 4.2.2.3.1), and enters the Idle RM-DEREGISTERED state, when the UE (124) needs to be no longer registered with the PLMN. The UE (124) may decide to deregister from the network at any time.
c) enters the Idle RM-DEREGISTERED state while receiving the Registration Reject message or a Deregistration message. The actions of the UE depend upon the cause value′ in the Registration Reject or Deregistration message (See TS 23.502 clause 4.2.2).
d) enters an idle and RM-REGISTERED state whenever the AN signalling connection is released.
e) enters the inactive and RM-REGISTERED for the UE (124) whenever AN signalling connection is suspended.

When the UE RM state in the CMF apparatus (154) is connected RM-REGISTERED, the CMF apparatus (154):
a) performs the deregistration procedure and enters the Idle RM-DEREGISTERED state for the UE (124), when the UE (124) needs to be no longer registered with the PLMN. The network may decide to deregister the UE (124) at any time.
b) performs Implicit Deregistration at any time after the Implicit Deregistration timer expires. The CMF (154) enters the Idle RM-DEREGISTERED state for the UE (124) after the implicit deregistration.
c) enters the idle RM-registered state when the AN context or N2 context is released.
d) enters idle and RM-REGISTERED for the UE (124) whenever a N2 connection is released.
e) enter inactive and RM-REGISTERED for the UE (124) whenever the N2 connection is suspended.

### Inactive and RM-REGISTERED

a) enters idle and RM-REGISTERED for the UE (124) whenever N2 connection/AN signalling is released
b) enter connected and RM-REGISTERED for the UE (124) whenever N2 connection/AN signalling is resumed

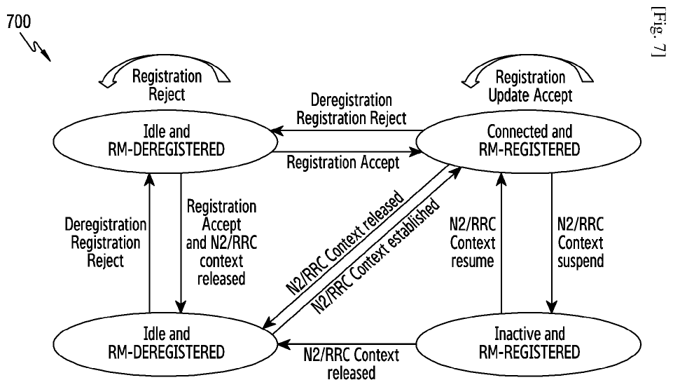

FIG. 9 illustrates a scenario of possible handover mechanism in the 6G network architecture, according to the embodiments as disclosed herein. The Hub (156) and the DU (142) can be integrated or can be separate also where single hub (156) is controlling multiple DU entities. In new mechanism below type of handover can be possible. In new proposed mechanism, it is assume that gNB (158a-158e) can consist of DU only or combination of the DU (142) or Hub (156). In another possible deployment, the HUB (156) is controlling multiple DU i.e. multiple gNB when the gNB only consist of the DU (142).
1. Intra gNB handover or Intra DU handover: the Hub (156) and DU (142) are considered to be part of gNB (158a-158e), then intra gNB handover includes change cell under same gNB (158a-158e). There can be another case where single HUB (156) is controlling multiple Dus in that case when the DU as well as HUB (156) is not changing then it is part of the intra gNB handover.
2. Inter gNB. Intra NF handover or inter DU handover: The NF entity can be handling multiple gNB or HUB (156) and DU (142). Whenever there is change in gNB (158a-158e) then the changes are handled by the NF entity in case there is no direct connection between multiple gNB (158a-158e). In this case, it is assumed that HUB (156) and DU have one to one mapping. There can be another case where single HUB is controlling multiple Dus or gNBs (158a-158e), in that case there is no change in HUB (156) but there is change in the DU (142). The changes are controlled by the NF entity.
3. Inter NF (within NF set or between NF) handover: The NF itself changes. The handover is equivalent to inter system handover. Here, the HUB (156), the DU (142) or gNB (158a-158e) consist of HUB (156) as well as the DU changes. The handover includes changes in the core network.

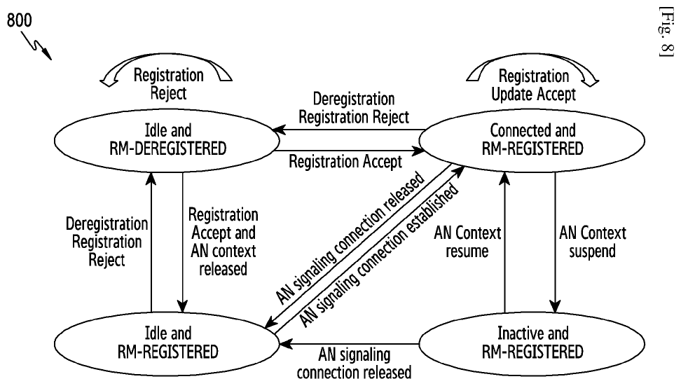

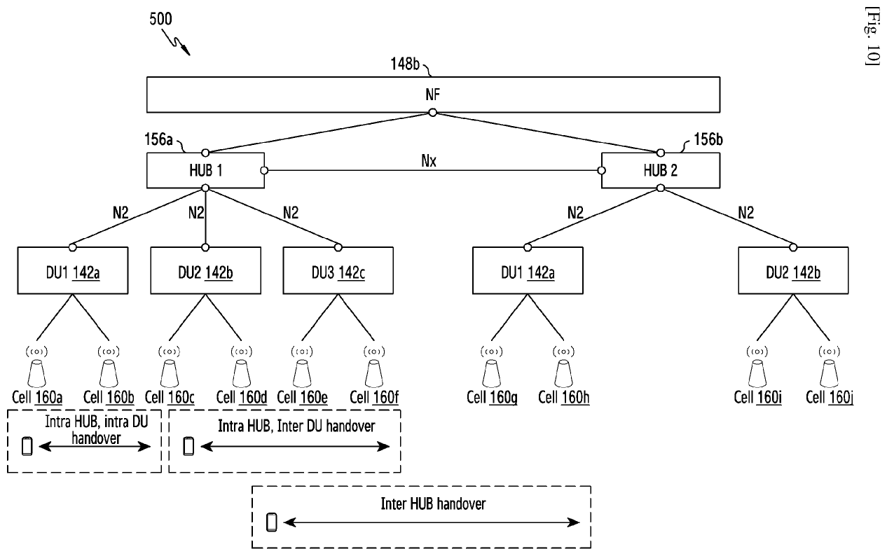

FIG. 10 illustrates a scenario of possibility for different types of handover in the 6G network architecture, according to the embodiments as disclosed herein. Apart from above mentioned cases, where the single HUB is controlling multiple DU entities. In this case, there is possibility for different types of handover as shown in the FIG. 13 and are as described below:

1. Intra HUB inter DU handover: The single HUB is handling multiple DU so inter DU handover case is possible. The inter DU handover case needs to be handled by the NF1 (148a).

2. Intra HUB intra DU handover: The HUB (156) and the DU (142) remains unchanged but cell (160) or TRP or RRH changes under the same DU (142).

3. Inter HUB handover: The handover can be possible in two ways. When connection between two HUBs exists, the handover can be possible over Xn or Nx interface with the minimal involvement from the NF entity. In case the connection between HUB (156) is not present then the handover is only possible through NF module. Once HUB changes, the DU (142) as well as RRH changes for the specific UE (124).

There are multiple NF entities and each NF is responsible for specific functionality as an example NF1 is handling all DU related functionality but the NF2 (148b) is responsible for handling all PDCP and data bearer related functionality. The NF1 (148a) can have connection management, handover, paging, etc whereas the NF2 (148b) can handle session management of PDU handling so. Whenever handover occurs there is need to have synchronization between these NF entities.
Intra gNB handover or Intra DU handover or Intra HUB handover: The procedure is used for the case that UE (124) moves from one cell (160a) to another cell (160b) within the same gNB-DU. When the intra-cell handover is performed, the NF1 (148a) or the HUB (156) provides new UL GTP TEID to the gNB-DU and the gNB-DU provides new DL GTP TEID to the NF1 (148a) or the HUB (156). The gNB-DU continues sending the UL PDCP PDUs to the HUB (156) or CU-UP (136) with the previous UL GTP TEID until it re-establishes the RLC, and use the new UL GTP TEID after RLC re-establishment. The HUB (156) or CU-UP (136) continues sending the DL PDCP PDUs to the gNB-DU with the previous DL GTP TEID until it performs PDCP re-establishment or PDCP data recovery, and use the new DL GTP TEID starting with the PDCP re-establishment or data recovery.

The procedure is used for the case when the UE (124) moves from one cell or TRP or RRH to another cell or TRP or RRH within the same gNBDU or the HUB (156) during proposed operation.

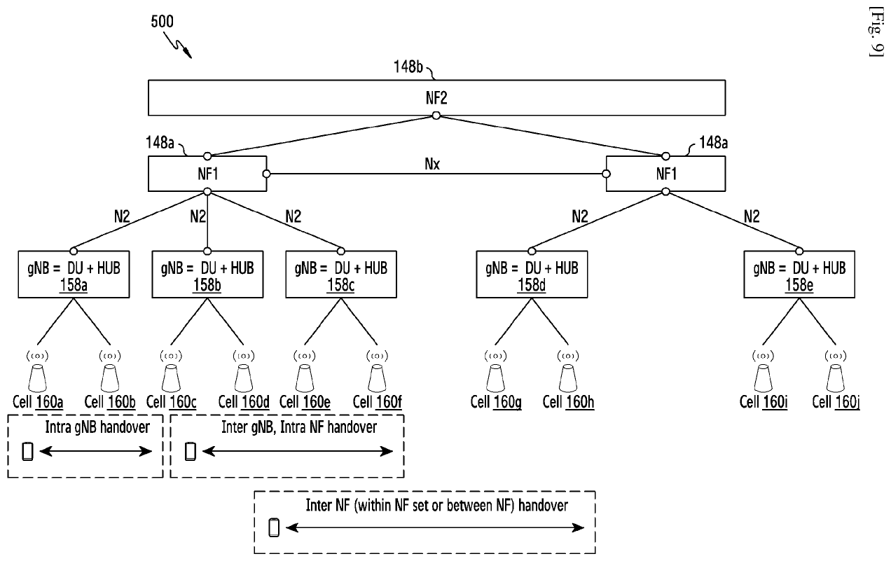

FIG. 11 illustrates an example scenario of an intra DU handover procedure, according to the embodiments as disclosed herein. The steps are as follows:
MeasurementReport: At step 1, the UE (124) sends a MeasurementReport message to the gNB (158a-158e) or the HUB (156) and then it further sends the report to NF1 (148a) (e.g., CMF (154)) including a serving cell and neighbouring cell signal strength.
Handover decision: At step 2, based on the measurement report, the NF1 (148a) decides to trigger the HO procedure.

At step 3, the NF1 (148a) sends the UE CONTEXT MODIFICATION REQUEST.

The message contains the UL GTP TEID for the DU (142) and also contains RRCReconfiguration for the UE (124) having target cell ID and the new C-RNTI.

At step 4, The gNB (158a-158e) further sends the RRC reconfiguration message to the UE (124) which includes target cell ID, the new C-RNTI to the UE (124), HUB ID and list of cells it supports for various services.

At step 5, the gNB (158a-158e) consist of the HUB (156) and DU send UE CONTEXT MODIFICATION RESPONSE including DL GTP TEID to the NF1 (148a) and NF1 (148a) either directly share the information with CU-UP (136) or send it to CU-UP (136) via the NF2 (148b).

At step 6, the UE (124) performs the RACH procedure over the new cell and send RRC reconfiguration complete to the NF1 (148a) through the gNB (158a-158e).

The same steps (1-6) and procedure is applicable during the intra HUB intra DU handover.

FIG. 12 illustrates an example scenario of an inter gNB or an inter DU mobility procedure, according to the embodiments as disclosed herein.

At step 1, the UE (124) sends a MeasurementReport message to the CMF apparatus (154). At step 2a, the UE context setup request is exchanged between the target gNB (158b) and the eSMF (120a). At step 2b, the bearer modification request/response is exchanged between the eSMF (120a) and the CU-UP (136).

At step 3, the NF2 (148b) (e.g., eSMF (120a)) further send Bearer & UE context setup Response to the NF1 (148a) or the CMF apparatus (154) and it also indicate with the PDCP re-establishment or data recovery. It can also send the UE context setup failure in case the NF2 did not able to successful setup or modify or delete the bearers. The procedure end their itself and handover need to be aborted. The procedure shares the below information, a list of DRBs which are successfully established, is included in the DRB setup List IE, a list of DRBs which failed to be established is included in the DRB Failed to Setup List IE, a list of SRBs which failed to be established is included in the SRB Failed to Setup List IE. A list of successfully established SRBs with logical channel identities for primary path is included in the SRB Setup List IE only when the CA based PDCP duplication is initiated for the concerned SRBs.

At step 4, the NF1 (148a) sends a UE CONTEXT MODIFICATION REQUEST message to the source gNB (158a), which includes a generated RRCReconfiguration message and indicates to stop the data transmission for the UE (124). The source gNB (158a) also sends the Downlink Data Delivery Status frame to inform the NF1 (148a) or the NF2 (148b) or the CU-CUP (136) about the unsuccessfully transmitted downlink data to the UE (124).

At step 5, the UE context modification response is exchanged to the CMF apparatus (154) from the source gNB. At step 6, the UE (124) sends the RRCReconfiguration message to the source gNB (158a), where the source gNB (158a) forwards the received RRCReconfiguration message to the CMF apparatus (154).

Further, the random access procedure is performed at the target gNB (158b). The target gNB (158b) sends a downlink data delivery status frame to inform the NF1 (148a). The downlink data delivery status frame, may include PDCP PDUs not successfully transmitted in the source gNB, is sent from the CU-UP (136) to the target gNB-DU.

At step 7, the UE (124) responds to the target gNB (158b) with an RRCReconfigurationComplete message. Further, The target gNB (158b) sends an UL RRC MESSAGE TRANSFER message to the NF1 (148a) to convey the received RRCReconfigurationComplete message. Downlink packets are sent to the UE (124). Also, uplink packets are sent from the UE (124), which are forwarded to the CU-UP (136) through the target gNB-DU.

At step 8, the NF1 (148a) sends an UE CONTEXT RELEASE COMMAND message to the source gNB-DU. At step 9, the source gNB-DU releases the UE context and responds the NF1 (148a) with an UE CONTEXT RELEASE COMPLETE message.

FIG. 13 illustrates an example sequence diagram of an inter gNB handover-inter NF mobility during a handover preparation phase, according to the embodiments as disclosed herein.
Inter gNB handover-Inter NF Mobility: The inter NF handover performs the preparation and execution phase of the handover procedure. The release of the resources at the source gNB during the handover completion phase is triggered by the target gNB. The steps are as follows:

At step 1, the UE (124) sends a MeasurementReport message to the source gNB (158a). At step 2, the source gNB (158a) sends a UL RRC MESSAGE TRANSFER (i.e., MeasurementReport) to the Source NF1 (148a) (i.e., source CMF apparatus). At step 3, the source NF1 (148a) takes decision to trigger handover which is T-CMF selection. The trigger can be done based on type of service UE required.

At step 4, the source NF1 (148a) sends the Nemf command request 1 to the target NF1 (148a) (i.e., target CMF apparatus). At step 5, the target NF1 (148a) sends PDU session update Request to the NF2 (148b) (e.g., eSMF (120a)).

At step 6, the NF2 (148b) makes the UPF selection and in between the target UPF (128b) and NF2 session establishment takes place. At step 7, the UPF (PSA) session modification interface takes place in between NF2 (148b) and the S-UPF (128a). At step 8, the NF2 (148b) sends the PDU session update Response to the target NF1. At step 9, the target NF1 sends NsmfComm Response to the source NF1.

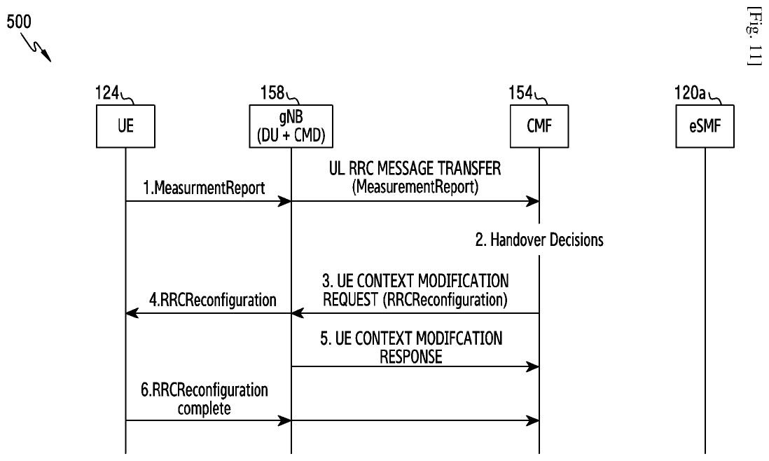

FIG. 14 illustrates an example sequence diagram of an inter gNB handover-inter NF mobility during a handover execution phase, according to the embodiments as disclosed herein. The steps are as follows:

At step 1, the Source NF1 (148a) (e.g., source CMF (154a)) sends a DRB Modification Request (Handover) to the NF2 (148b) (e.g., eSMF (120a)), which is new step for synchronization as DRB with NF2 (148b) as different configuration are placed at different NF. The indication is needed as bearer configuration is with the NF2 (148b) and there is need to have some synchronization between them. On receiving the same, the NF2 (148b) further triggers the reset/re-establishment related procedure for data bearers and addition/deletion of data bearers. The another possibility is the NF1 (148a) can only mention to the NF2 (148b) about services it want to retain. Accordingly, the NF2 (148b) can take the call for action on existing of data bearers or addition of new bearers or deletion of data bearers depending upon type of service new cell or DU supports.

At step 2, the NF2 (148b) sends back the DRB modification response. The DRB modification response shares the below information such as A list of DRBs which are successfully established is included in the DRB Setup List IE, a list of DRBs which failed to be established is included in the DRB Failed to Setup List IE, a list of SRBs which failed to be established shall be included in the SRB Failed to Setup List IE. A list of successfully established SRBs with logical channel identities for primary path shall be included in the SRB Setup List IE only when the CA based PDCP duplication is initiated for the concerned SRBs.

At step 3, the source NF1 (148a) sends the RRC Reconfiguration (i.e., the Handover Command) to the source gNB (158a). At step 4, the source gNB (158a) sends the RRC Reconfiguration to the UE (124) (here status transfer takes place).

At step 5, the UE (124) sends the RRC Reconfiguration complete message to the target gNB and Target NF1 (148a) (i.e., target CMF apparatus). At step 6, After the above step, NamfComm Notify notifies in between the source NF1 (148a) and the target NF1 (148a).

At step 7, the target NF1 (148a) sends PDU session update request to the NF2 (148b). (after that, session modification takes place in between the target UPF (128b), the NF2 (148b), the S-UPF (128a) and the UPF (PSA) (128c)). At step 8, the NF2 (148b) sends the PDU session update response to the target NF1 (148a). At step 9, the registration procedure gets completed after all of these steps.

The rest all of the procedures and steps details (e.g., UE context release command, UE context release complete) are same as mentioned in existing art of the 5G.

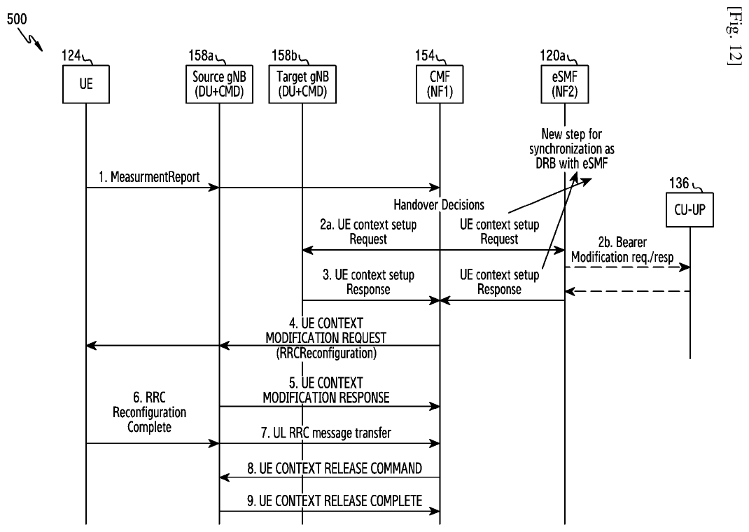

FIG. 15 illustrating a scenario of the intra gNB handover with respect to the hub change procedure, according to the embodiments as disclosed herein.
Intra gNB HO with respect to the HUB change: Both the HUB (156) and the DU (142) are placed at same location or can be deployed at different location i.e. HUB can be handling multiple DU. The steps are as follows:

At step 1, the UE (124) sends a MeasurementReport message to the source gNB-DU. At step 2, the source gNB-DU sends an UL RRC MESSAGE TRANSFER message to the NF1 (148a) to convey the received MeasurementReport message.

At step 3, the NF1 (148a) sends an UE CONTEXT SETUP REQUEST message to the NF2 (148b) for the functionality like session management (SM). In this case, it is assumed that SM is handled by the NF2 (148b). At step 4, the NF2 (148b) responds the UE CONTEXT SETUP RESPONSE message. It also indicates any change in the session management.

At step 5, the NF1 (148a) sends an UE CONTEXT SETUP REQUEST message to the target gNB-DU to create an UE context. The UE CONTEXT SETUP REQUEST message includes a HandoverPreparationInformation for both connection and session management.

At step 6, the target gNB-DU responds to the NF1 (148a) with an UE CONTEXT SETUP RESPONSE message. At step 7, the NF1 (148a) then further sends UE context modify request to the NF2 (148b) for modifying session and setup or modifying the bearers.

At step 8, the NF2 (148b) further send bearer context modification request/response to CU-UP (136) and setup and modify the bearers.

At step 9, the NF2 (148b) then sends UE context modification response and also indicate the new bearer setup or modification of existing bearers along with PDCP re-establishment and recovery indication. At step 10, the NF1 (148a) sends a UE CONTEXT MODIFICATION REQUEST message to the source gNB-DU, which includes a generated RRCReconfiguration message and indicates to stop the data transmission for the UE (124). The source gNB-DU also sends a Downlink Data Delivery Status frame to inform the NF1 (148a) or the NF2 (148b) or CU-CUP about the unsuccessfully transmitted downlink data to the UE (124).

At step 11, the source gNB-DU forwards the received RRCReconfiguration message to the UE (124). At step 12, The random access procedure is performed at the target gNB-DU. The target gNB-DU sends a Downlink Data Delivery Status frame to inform the NF1 (148a). Downlink packets, which may include PDCP PDUs not successfully transmitted in the source gNB-DU, are sent from the CU-UP (136) to the target gNB-DU.

At step 13, the UE (124) responds to the target gNB-DU with an RRCReconfigurationComplete message which is further send to both NF1 (148a) and the NF2 (148b). At step 14, the NF2 (148b) sends an UE CONTEXT RELEASE COMMAND message to the NF1 (148a) and which have been further sent source gNB-DU. At step 15, the source gNB-DU releases the UE context and responds the NF1 (148a) with an UE CONTEXT RELEASE COMPLETE message and share the same with the NF2 (148b).

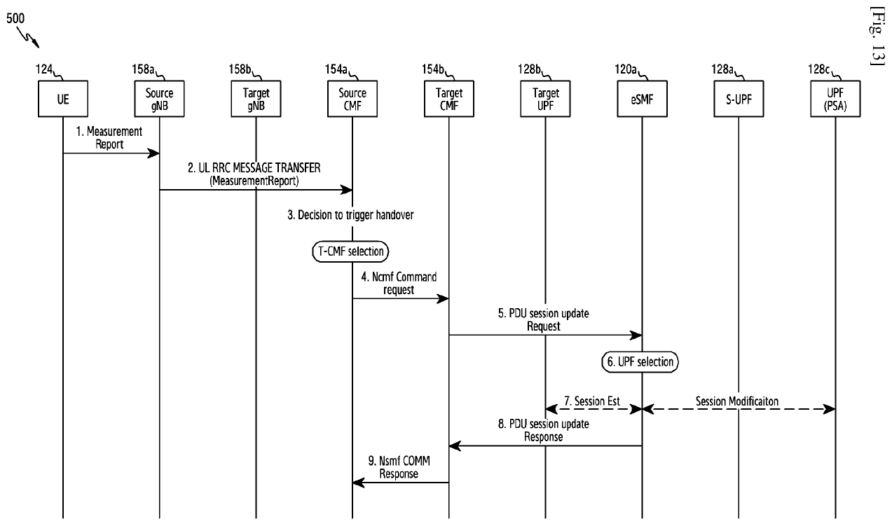

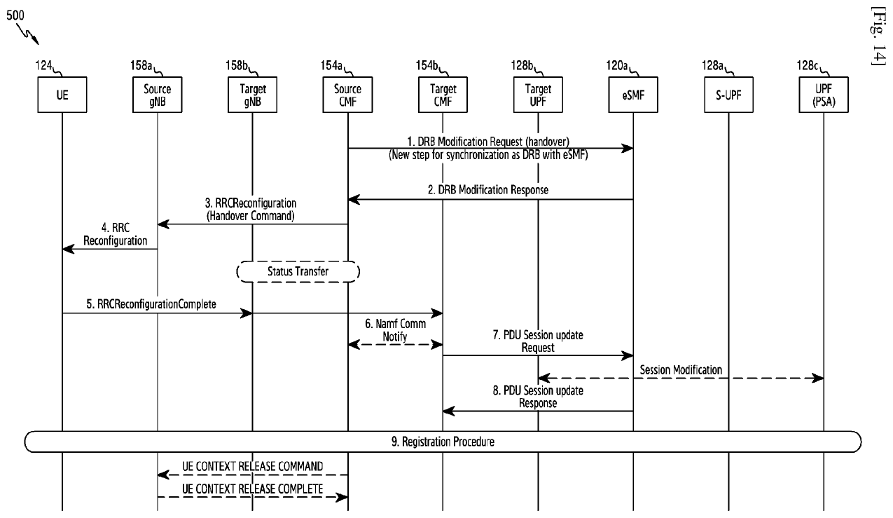

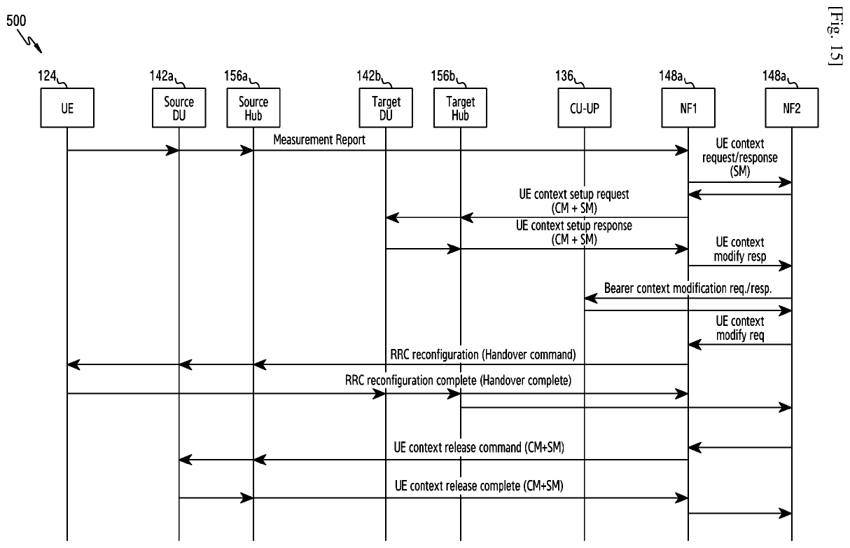

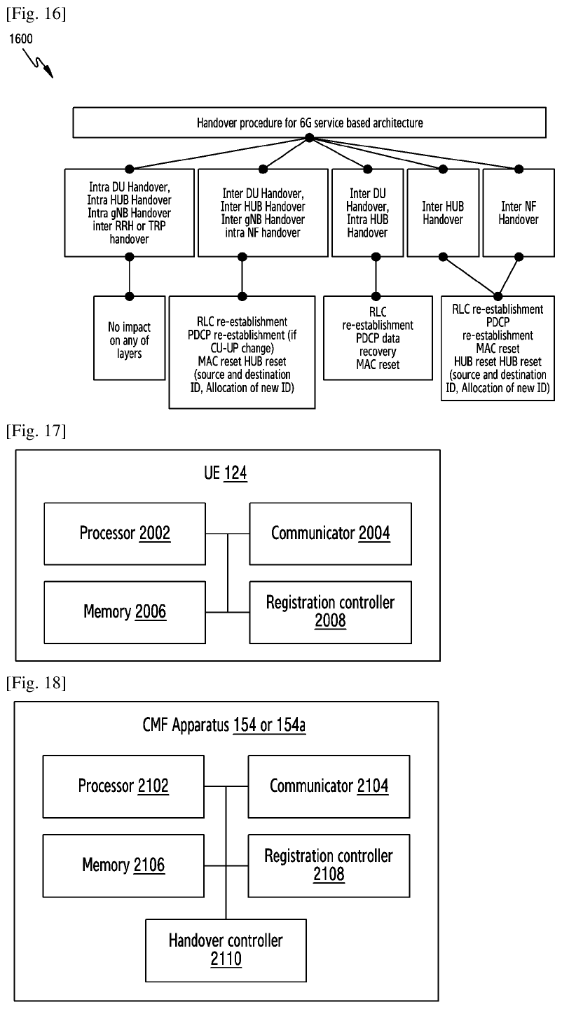

FIG. 16 illustrating impacts on various layers for various handover procedure (1600), according to the embodiments as disclosed herein. The handover procedure consists of following handover types:
1. Intra DU handover, Intra HUB handover, Intra gNB handover, inter RRH or TRP handover
   a. The handover is not impact on any of layers, the UE (124) simply moves to the new configuration. The telecommunication network (500) may choose not to reset or re-establish any of the layers. Alternatively, UE (124) can send reset and re-establish commands and can also modify the bearers or current context, if needed.
2. Inter DU handover, Inter HUB handover, Inter gNB handover, Intra NF handover
   a. NW can provide RLC re-establishment, PDCP re-establishment (when CU-UP changes), MAC reset, SDAP reset or re-establish HUB reset (source and destination ID, Allocation of new ID). As part of HUB reset or re-establish or reset network may clear all pending data which is stored at HUB (156).
3. Inter DU handover, Intra HUB handover
   a. Network can provide RLC re-establishment, PDCP data recovery, SDAP reset or re-establish and MAC reset
4. Inter HUB handover, and
5. Inter NF handover.
   a. Both Inter HUB handover and Inter NF handover provides RLC re-establishment, PDCP re-establishment, MAC reset and HUB reset HUB reset (source and destination ID, Allocation of new ID)

Below steps need to be taken when the telecommunication network (500) performs HUB re-establishment or HUB reset. There are two cases:
1. Case 1: the HUB (156) does not have PDCP entity—the HUB (156) discards all the pending data and transfer it to respective NF entity or can simply discard the packets. When there is change in source and destination address, it again forms these packets and send it to the NF entity accordingly. Any timers or variables at the HUB (156) is reset or stopped.
2. Case 2: when the HUB (156) has PDCP entity, the HUB (156) performs these additional steps if it has PDCP entity. When the network request a PDCP entity re-establishment, the transmitting PDCP entity:
a. for UM DRBs and AM DRBs, resets the header compression protocol for uplink and start with an IR state in U-mode (as defined in the RFC 3095 and the RFC 4815)
b. For UM DRBs and SRBs, sets TX_NEXT to the initial value;
i. for SRBs, discard all stored PDCP SDUs and PDCP PDUs;
ii. Applies the ciphering algorithm and key provided by upper layers during the PDCP entity re-establishment procedure;
iii. Applies the integrity protection algorithm and key provided by upper layers during the PDCP entity reestablishment procedure;
iv. for UM DRBs, for each PDCP SDU already associated with a PDCP SN but for which a corresponding PDU has not previously been submitted to lower layers: consider the PDCP SDUs as received from upper layer;
v. performs transmission of the PDCP SDUs in ascending order of the COUNT value associated to the PDCP SDU prior to the PDCP re-establishment without restarting the discardTimer,
vi. performs transmission by creating new header based on new configuration provided by the network which has new address or new identifier.
vii. For AM DRBs, from the first PDCP SDU for which the successful delivery of the corresponding PDCP Data PDU has not been confirmed by lower layers, performs retransmission or transmission of all the PDCP SDUs already associated with PDCP SNs in ascending order of the COUNT values associated to the PDCP SDU prior to the PDCP entity re-establishment as specified below:—perform header compression of the PDCP SDU-perform integrity protection and ciphering of the PDCP SDU using the COUNT value associated with the PDCP SDU-submit the resulting PDCP Data PDU to lower layer, following the data submission procedure.

When upper layers request a PDCP entity re-establishment, the receiving PDCP entity:-processes the PDCP Data PDUs that are received from lower layers due to the re-establishment of the lower layers,—for SRBs, discards all stored PDCP SDUs and PDCP PDUs;—for SRBs and UM DRBs, when t-Reordering is running:—stop and reset t-Reordering;—for UM DRBs, delivers all stored PDCP SDUs to the upper layers in ascending order of associated COUNT values after performing header decompression;—for AM DRBs, performs header decompression for all stored PDCP SDUs when drb-ContinueROHC is not configured—for UM DRBs and AM DRBs, reset the header compression protocol for downlink and start with NC state in Umode (as defined in the RFC 3095 and the RFC 4815).
1. for UM DRBs and SRBs, set RX_NEXT and RX_DELIV to the initial value;-apply the ciphering algorithm and key provided by upper layers during the PDCP entity re-establishment procedure;-apply the integrity protection algorithm and key provided by upper layers during the PDCP entity reestablishment procedure.
2. perform transmission by creating new header based on new configuration provided by the network which has new address or new identifier.

FIG. 17 shows various hardware components of the UE (124), according to the embodiments as disclosed herein. The UE (124) includes a processor (2002), a communicator (2004), a memory (2006) and a registration controller (2008). The processor (2002) is coupled with the communicator (2004), the memory (2006) and the registration controller (2008).

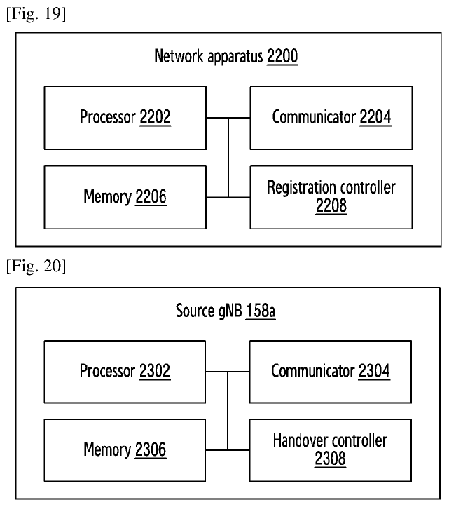

The registration controller (2008) sends the registration request message to the network apparatus (2200) (as shown in FIG. 19). The registration request message can be, for example, but not limited to the registration type, the SUCI, the 5G-GUTI, the PEI, the last visited TAI, the security parameters, the requested NSSAI for the UE (124), the mapping of NSSAI for the UE (124), the radio capability update of the UE (124), the MM Core network capability of the UE (124), the PDU session status associated with the UE (124), the list of PDU Sessions to be activated for the UE (124), the follow on request, the MICO mode preference of the UE (124), the requested DRX parameters of the UE (124), the policy container of the UE (124), and the UE Context. Further, the registration controller (2008) receives the authentication request from the CMF apparatus (154) through the network apparatus (2200), where the CMF apparatus (154) is selected by the network apparatus (2200) upon receiving the registration request message from the UE (124).

Further, the registration controller (208) performs the authentication process and sending an authentication response message to the CMF apparatus (154) selected by the network apparatus (2200). Further, the registration controller (2008) sends the UE capability response message comprising the UE capability to the CMF apparatus (154) through the network apparatus (2200). Further, the registration controller (2008) receives the security mode command from the CMF apparatus (154) through the network apparatus (2200). Further, the registration controller (2008) sends the security mode complete response to the CMF apparatus (154) through the network apparatus. Further, the registration controller (2008) receives the registration accept message from the CMF apparatus (154) through the network apparatus.

The registration controller (2008) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (2002) is configured to execute instructions stored in the memory (2006) and to perform various processes. The communicator (2004) is configured for communicating internally between internal hardware components and with external devices via one or more networks. The memory (2006) also stores instructions to be executed by the processor (2002). The memory (2006) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (2006) may, in some examples, be considered a non-transitory storage medium. The term “non-transitory” may indicate that the storage medium is not embodied in a carrier wave or a propagated signal. The term “non-transitory” should not be interpreted that the memory (2006) is non-movable. In certain examples, a non-transitory storage medium may store data that can, over time, change (e.g., in Random Access Memory (RAM) or cache).

Although the FIG. 17 shows various hardware components of the UE (124) but it is to be understood that other embodiments are not limited thereon. In other embodiments, the UE (124) may include less or more number of components. Further, the labels or names of the components are used only for illustrative purpose and does not limit the scope of the invention. One or more components can be combined together to perform same or substantially similar function in the UE (124).

FIG. 18 shows various hardware components of the CMF apparatus (154), according to the embodiments as disclosed herein. The CMF apparatus (154) is the NF apparatus comprising a combination of the RRC node, the AMF node (118), and the SMF node (120) in the telecommunication network (500) (e.g., 6G network). The CMF apparatus (154) handles at least one of all RRC operations, the NAS operations, the connection establishment operations, the registration procedure, the handover operations, the radio link control operations and the MAC operations.

The CMF apparatus (154) includes a processor (2102), a communicator (2104), a memory (2106), a registration controller (2108) and a handover controller (2110). The processor (2102) is coupled with the communicator (2104), the memory (2106), the registration controller (2108) and the handover controller (2110). The registration controller (2108) receives the registration request from the UE (124) through the network apparatus (2200), where the CMF apparatus (154) is selected by the network apparatus (2200) upon receiving the registration request message from the UE (124).

The network apparatus (2200) is one of the hub (156), the CMD (152), and the switch and acts as a single anchor point for all UE messages. The network apparatus (2200) is one of located at independently in the telecommunication network (500), located in NF at a core network in the telecommunication network (500), and located in a DU at a RAN in the telecommunication network (500).

Further, the registration controller (2108) sends the authentication request message and the UE capability enquiry request message to the UE (124) through the network apparatus (2200). In an embodiment, the registration controller (2108) selects a NFx based on at least one of the SUPI and the SUCI and invokes the NFx for authenticating the UE (124). Further, the registration controller selects a NFy for authenticating the UE (124).

Further, the registration controller (2108) receives the authentication response message and the UE capability response message comprising the UE capability from the UE (124) through the network apparatus (2200). Further, the registration controller (2108) sends the security mode command to the UE (124) through the network apparatus (2200). Further, the registration controller receives the security mode complete response from the UE (124) through the network apparatus (2200). Further, the registration controller (2108) sends the registration accept message to the UE (124) through the network apparatus (2200). The registration accept message comprises the 5G-GUTI, the registration area for the UE (124), the mobility restrictions for the UE (124), the PDU session status of the UE (124), the allowed NSSAI for the UE (124), mapping of the allowed NSSAI for the UE (124), configured NSSAI for a serving PLMN associated with the UE (124), mapping of configured NSSAI for the UE (124), a periodic registration update timer, a LADN information and accepted MICO mode, an IMS Voice over PS session supported indication, an emergency service support indicator, accepted DRX parameters, Network support of Interworking, and a network slicing subscription change indication.

The handover controller (2110) receives the RRC message including the measurement report received from the UE (124) from the source gNB-DU. Further, the handover controller (2110) determines whether the handover is required for the UE (124) based on the received measurement report of the UE (124). Further, the handover controller (2110) sends a RRC Reconfiguration message indicating handover requirement to the source gNB-DU, when the source CMF apparatus (154a) determines that the handover is required for the UE (124).

The registration controller (2108) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The handover controller (2110) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (2110) is configured to execute instructions stored in the memory (2106) and to perform various processes. The communicator (2104) is configured for communicating internally between internal hardware components and with external devices via one or more networks. The memory (2106) also stores instructions to be executed by the processor (2102). The memory (2106) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (2106) may, in some examples, be considered a non-transitory storage medium. The term “non-transitory” may indicate that the storage medium is not embodied in a carrier wave or a propagated signal. The term “non-transitory” should not be interpreted that the memory (2106) is non-movable. In certain examples, a non-transitory storage medium may store data that can, over time, change (e.g., in Random Access Memory (RAM) or cache).

Although the FIG. 18 shows various hardware components of the CMF apparatus (154) but it is to be understood that other embodiments are not limited thereon. In other embodiments, the CMF apparatus (154) may include less or more number of components. Further, the labels or names of the components are used only for illustrative purpose and does not limit the scope of the invention. One or more components can be combined together to perform same or substantially similar function in the CMF apparatus (154).

FIG. 19 shows various hardware components of the network apparatus (2200), according to the embodiments as disclosed herein. The network apparatus (2200) includes a processor (2202), a communicator (2204), a memory (2206), and a registration controller (2208). The processor (2202) is coupled with the communicator (2204), the memory (2206), and the registration controller (2208).

The registration controller (2208) receives the registration request message from the UE (124). Further, the registration controller (2208) selects the CMF apparatus (154) based on the SIB information. The SIB information includes the type of service, the NF ID, and the cell ID with type of service. Further, the registration controller (2208) forwards the registration request message to the selected CMF apparatus (154). In an embodiment, the registration controller (2208) determines whether the UE (124) is in a connected state. Further, the registration controller (2208) forwards the registration request message to the selected CMF apparatus (154) based on a SBI connection of the UE (124). Further, the registration controller (2208) controls exchange of messages between the UE (124) and the selected CMF apparatus (154) for registration of the UE (124) in the telecommunication network (500).

The registration controller (2208) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (2202) is configured to execute instructions stored in the memory (2206) and to perform various processes. The communicator (2204) is configured for communicating internally between internal hardware components and with external devices via one or more networks. The memory (2206) also stores instructions to be executed by the processor (2202). The memory (2206) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (2206) may, in some examples, be considered a non-transitory storage medium. The term “non-transitory” may indicate that the storage medium is not embodied in a carrier wave or a propagated signal. The term “non-transitory” should not be interpreted that the memory (2206) is non-movable. In certain examples, a non-transitory storage medium may store data that can, over time, change (e.g., in Random Access Memory (RAM) or cache).

Although the FIG. 19 shows various hardware components of the network apparatus (2200) but it is to be understood that other embodiments are not limited thereon. In other embodiments, the network apparatus (2200) may include less or more number of components. Further, the labels or names of the components are used only for illustrative purpose and does not limit the scope of the invention. One or more components can be combined together to perform same or substantially similar function in the network apparatus (2200).

FIG. 20 shows various hardware components of the source gNB (158a), according to the embodiments as disclosed herein. The source gNB (158a) includes a processor (2302), a communicator (2304), a memory (2306), and a handover controller (2308). The processor (2302) is coupled with the communicator (2304), the memory (2306), and the handover controller (2308).

The handover controller (2308) receives the measurement report from the UE (124) in the telecommunication network (500) and sends the RRC message including the measurement report received from the UE (124) to the source CMF apparatus (154a). The RRC message is a UL RRC transfer message. Further, the handover controller (2308) receives a RRC Reconfiguration message indicating handover requirement from the source CMF apparatus (154a). In an embodiment, the handover controller (2308) receives a UE context modification request message comprising the RRC Reconfiguration message from the CMF apparatus (154). Further, the handover controller (2308) sends the UE context modification response message to the source CMF apparatus (154a) indicating that the RRC Reconfiguration message is sent to the UE (124). Further, the handover controller (2308) sends the RRC reconfiguration message to the UE (124) for initiating the handover. Further, exchange of messages between the UE (124) and the source CMF apparatus (154a) is controlled through the network apparatus (2200).

FIG. 21 is a flow chart (S2100) illustrating a method, implemented by the CMF apparatus (154), for registering the UE (124) in the telecommunication network (500), according to the embodiments as disclosed herein. The operations (S2102-S2112) are handled by the registration controller (2108).

At S2102, the method includes receiving the registration request from the UE (124) through the network apparatus (2200). The CMF apparatus (154) is selected by the network apparatus (2200) upon receiving the registration request message from the UE (124). At S2104, the method includes sending the authentication request message and the UE capability enquiry request message to the UE (124) through the network apparatus (2200). At S2106, the method includes receiving the authentication response message and the UE capability response message comprising the UE capability from the UE (124) through the network apparatus (2200). At S2108, the method includes sending the security mode command to the UE (124) through the network apparatus (2200). At S2110, the method includes receiving the security mode complete response from the UE (124) through the network apparatus (2200). At S2112, the method includes sending the registration accept message to the UE (124) through the network apparatus (2200).

FIG. 22 is a flow chart (S2200) illustrating a method, implemented by the UE (124), for registering the UE (124) in the telecommunication network (500), according to the embodiments as disclosed herein. The operations (S2202-S2214) are handled by the registration controller (2008).

At step S2202, the method includes sending the registration request message to the network apparatus (2200). At step S2204, the method includes receiving the authentication request from the CMF apparatus (154) through the network apparatus (2200). The CMF apparatus (154) is selected by the network apparatus (2200) upon receiving the registration request message from the UE (124). At step S2206, the method includes performing the authentication process and sending the authentication response message to the CMF apparatus (154) selected by the network apparatus (2200). At step S2208, the method includes sending the UE capability response message comprising the UE capability to the CMF apparatus (154) through the network apparatus (2200).

At step S2210, the method includes receiving the security mode command from the CMF apparatus (154) through the network apparatus (2200). At step S2212, the method includes sending the security mode complete response to the CMF apparatus (154) through the network apparatus (2200). At step S2214, the method includes receiving the registration accept message from the CMF apparatus (154) through the network apparatus (2200).

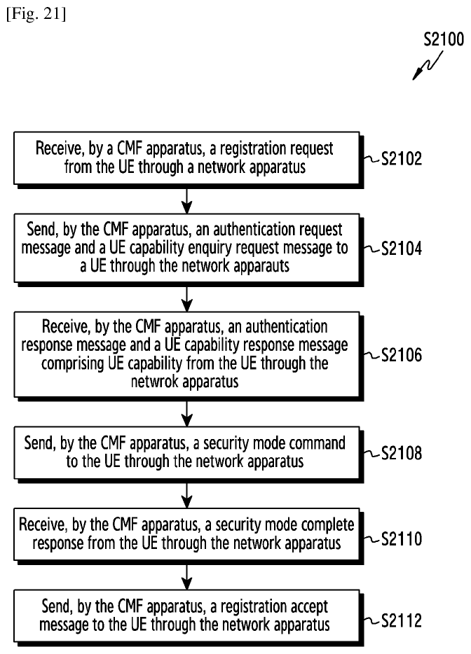

FIG. 23 is a flow chart (S2300) illustrating a method, implemented by the network apparatus (2200), for registering the UE (124) in the telecommunication network (500), according to the embodiments as disclosed herein. The operations (S2302-S2308) are handled by the registration controller (2208).

At step S202, the method includes receiving the registration request message from the UE (124). At step S2304, the method includes selecting the CMF apparatus (154) based on the SIB information. At step S2306, the method includes forwarding the registration request message to the selected CMF apparatus (154). At step S2308, the method includes controlling the exchange of messages between the UE (124) and the selected CMF apparatus (154) for registration of the UE (124) in the telecommunication network (500).

FIG. 24 is a flow chart (S2400) illustrating a method, implemented by a source gNB-DU (158a), for handling handover in the telecommunication network (500), according to the embodiments as disclosed herein. The operations (S2402-S2408) are handled by the handover controller (2308).

At step S2402, the method includes receiving the measurement report from the UE (124) in the telecommunication network (500). At step S2404, the method includes sending the RRC message including the measurement report received from the UE (124) to the source CMF apparatus (154a). At step S2406, the method includes receiving the RRC reconfiguration message indicating the handover requirement from the source CMF apparatus (154a). At step S2408, the method includes sending the RRC Reconfiguration message to the UE (124) for initiating the handover.

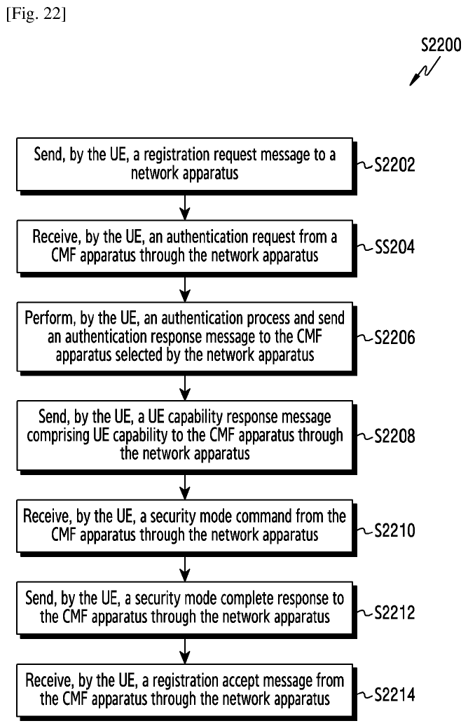

FIG. 25 is a flow chart (S2500) illustrating a method, implemented by the source CMF apparatus (154a), for handling handover in the telecommunication network (500), according to the embodiments as disclosed herein. The operations (S2502-S2506) are handled by the handover controller (2110).

At step S2502, the includes receiving the RRC message including the measurement report received from the UE (124) from the source gNB-DU. At step S2504, the method includes determining whether the handover is required for the UE (124) based on the received measurement report of the UE (124). At step S2506, the method includes sending the RRC reconfiguration message indicating handover requirement to the source gNB-DU when the source CMF apparatus (154a) determines that the handover is required for the UE (124).

The various actions, acts, blocks, steps, or the like in the flow charts (S2100-S2500) may be performed in the order presented, in a different order or simultaneously. Further, in some embodiments, some of the actions, acts, blocks, steps, or the like may be omitted, added, modified, skipped, or the like without departing from the scope of the invention.

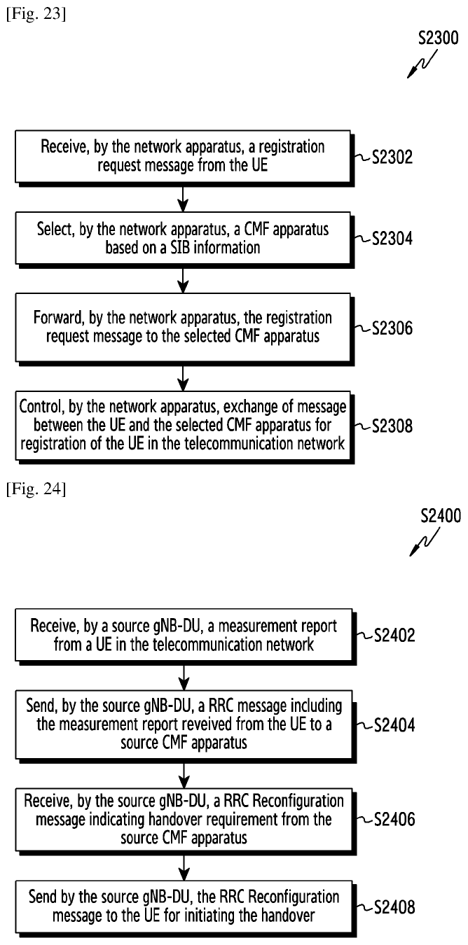

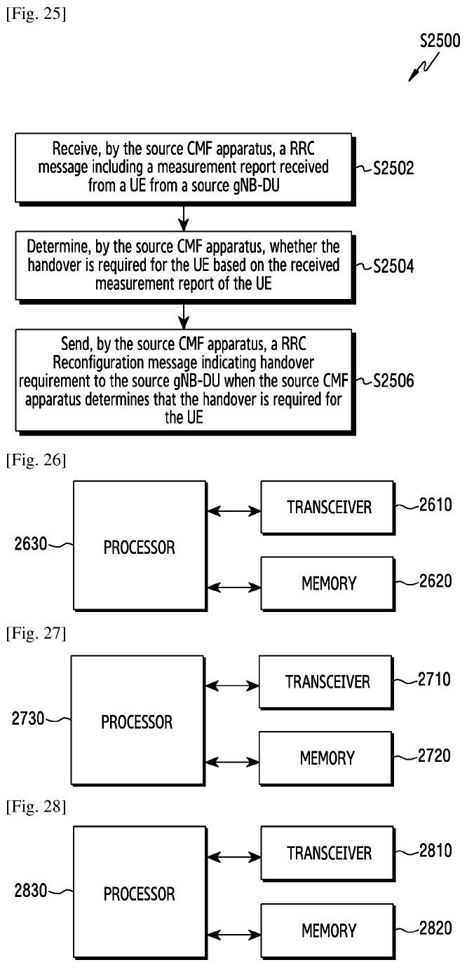

FIG. 26 illustrates a block diagram of a terminal (or a user equipment (UE)), according to embodiments of the present disclosure.

As shown in FIG. 26, a terminal according to an embodiment may include a transceiver 2610, a memory 2620, and a processor (or a controller) 2630. The transceiver 2610, the memory 2620, and the processor (or controller) 2630 of the terminal may operate according to a communication method of the terminal described above. However, the components of the terminal are not limited thereto. For example, the terminal may include more or fewer components than those described in FIG. 26. In addition, the processor (or controller) 2630, the transceiver 2610, and the memory 2620 may be implemented as a single chip. Also, the processor (or controller) 2630 may include at least one processor.

The transceiver 2610 collectively refers to a terminal station receiver and a terminal transmitter, and may transmit/receive a signal to/from a base station or another terminal. The signal transmitted or received to or from the terminal may include control information and data. The transceiver 2610 may include a RF transmitter for up-converting and amplifying a frequency of a transmitted signal, and a RF receiver for amplifying low-noise and down-converting a frequency of a received signal. However, this is only an example of the transceiver 2610 and components of the transceiver 2610 are not limited to the RF transmitter and the RF receiver.

Also, the transceiver 2610 may receive and output, to the processor (or controller) 2630, a signal through a wireless channel, and transmit a signal output from the processor (or controller) 2630 through the wireless channel.

The memory 2620 may store a program and data required for operations of the terminal. Also, the memory 2620 may store control information or data included in a signal obtained by the terminal. The memory 2620 may be a storage medium, such as read-only memory (ROM), random access memory (RAM), a hard disk, a CD-ROM, and a DVD, or a combination of storage media.

The processor (or controller) 2630 may control a series of processes such that the terminal operates as described above. For example, the processor (or controller) 2630 may receive a data signal and/or a control signal, and the processor (or controller) 2630 may determine a result of receiving the signal transmitted by the base station and/or the other terminal.

FIG. 27 illustrates a block diagram of a base station, according to embodiments of the present disclosure. The base station of FIG. 27 may refer to a transmission and reception point (TRP) described above.

As shown in FIG. 27 is, the base station of the present disclosure may include a transceiver 2710, a memory 2720, and a processor (or, a controller) 2730. The transceiver 2710, the memory 2720, and the processor (or controller) 2730 of the base station may operate according to a communication method of the base station described above. However, the components of the base station are not limited thereto. For example, the base station may include more or fewer components than those described in FIG. 27. In addition, the processor (or controller) 2730, the transceiver 2710, and the memory 2720 may be implemented as a single chip. Also, the processor (or controller) 2730 may include at least one processor.

The transceiver 2710 collectively refers to a base station receiver and a base station transmitter, and may transmit/receive a signal to/from a terminal, another base station, and/or a core network function(s) (or entity(s)). The signal transmitted or received to or from the base station may include control information and data. The transceiver 2710 may include a RF transmitter for up-converting and amplifying a frequency of a transmitted signal, and a RF receiver for amplifying low-noise and down-converting a frequency of a received signal. However, this is only an example of the transceiver 2710 and components of the transceiver 2710 are not limited to the RF transmitter and the RF receiver.

Also, the transceiver 2710 may receive and output, to the processor (or controller) 2730, a signal through a wireless channel, and transmit a signal output from the processor (or controller) 2730 through the wireless channel.

The memory 2720 may store a program and data required for operations of the base station. Also, the memory 2720 may store control information or data included in a signal obtained by the base station. The memory 2720 may be a storage medium, such as ROM, RAM, a hard disk, a CD-ROM, and a DVD, or a combination of storage media.

The processor (or controller) 2730 may control a series of processes such that the base station operates as described above. For example, the processor (or controller) 2730 may receive a data signal and/or a control signal, and the processor (or controller) 2730 may determine a result of receiving the signal transmitted by the terminal and/or the core network function.

FIG. 28 illustrates a block diagram of a network entity according to an embodiment of the disclosure.

As shown in FIG. 28, the network entity of the present disclosure may include a transceiver 2810, a memory 2820, and a processor 2830. The transceiver 2810, the memory 2820, and the processor 2830 of the network entity may operate according to a communication method of the network entity described above. However, the components of the terminal are not limited thereto. For example, the network entity may include more or fewer components than those described above. In addition, the processor 2830, the transceiver 2810, and the memory 2820 may be implemented as a single chip. Also, the processor 2830 may include at least one processor. Furthermore, the network entity illustrated in FIG. 28 may correspond to the network entity (e.g., AMF entity (118) or SMF entity (120) illustrated in FIG. 1 to FIG. 25).

The transceiver 2810 collectively refers to a network entity receiver and a network entity transmitter, and may transmit/receive a signal to/from a base station or a UE. The signal transmitted or received to or from the base station or the UE may include control information and data. In this regard, the transceiver 2810 may include a RF transmitter for up-converting and amplifying a frequency of a transmitted signal, and a RF receiver for amplifying low-noise and down-converting a frequency of a received signal. However, this is only an example of the transceiver 2810 and components of the transceiver 2810 are not limited to the RF transmitter and the RF receiver.

Also, the transceiver 2810 may receive and output, to the processor 2830, a signal through a wireless channel, and transmit a signal output from the processor 2830 through the wireless channel.

The memory 2820 may store a program and data required for operations of the network entity. Also, the memory 2820 may store control information or data included in a signal obtained by the network entity. The memory 2820 may be a storage medium, such as ROM, RAM, a hard disk, a CD-ROM, and a DVD, or a combination of storage media.

The processor 2830 may control a series of processes such that the network entity operates as described above. For example, the transceiver 2810 may receive a data signal including a control signal, and the processor 2830 may determine a result of receiving the data signal.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this inter-changeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors co-operating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the present invention, and is not intended to limit the scope of protection of the present invention, which is determined by the appended claims.

The embodiment herein is to provide a method for registering a User Equipment (UE) (124) in a telecommunication network (500). The method includes receiving by a Connection management function (CMF) apparatus (154), a registration request from the UE (124) through a network apparatus (2200), wherein the CMF apparatus (154) is selected by the network apparatus (2200) upon receiving a registration request message from the UE (124). Further, the method includes sending, by the CMF apparatus (154), an authentication request message and a UE capability enquiry request message to the UE (124) through the network apparatus (2200). Further, the method includes receiving, by the CMF apparatus (154), an authentication response message and a UE capability response message comprising UE capability from the UE (124) through the network apparatus (2200). Further, the method includes sending, by the CMF apparatus (154), a security mode command to the UE (124) through the network apparatus (2200). Further, the method includes receiving, by the CMF apparatus (154), a security mode complete response from the UE (124) through the network apparatus (2200). Further, the method includes sending, by the CMF apparatus (154), a registration accept message to the UE (124) through the network apparatus (2200).

In an embodiment, sending, by the CMF apparatus (154), the authentication request message comprises selecting, by the CMF apparatus (154), a NF based on at least one of a SUPI and a SUCI, invoking, by the CMF apparatus (154), a NF for authenticating the UE, and selecting, by the CMF apparatus (154), a NF for authenticating the UE (124).

In an embodiment, the network apparatus (2200) is one of a hub (156), a CMD (152), and a switch and act as a single anchor point for all UE messages, and wherein the network apparatus (2200) is one of located at independently in the telecommunication network (500), located in a NF at a core network in the telecommunication network (500), and located in a Distributed Unit (DU) at a Radio Access Network (RAN) in the telecommunication network (500).

In an embodiment, the CMF apparatus (154) is a NF apparatus comprising a combination of a RRC node, an AMF node (118), and a SMF node (120) in the telecommunication network (500), and wherein the CMF apparatus (154) handles at least one of all RRC operations, NAS operations, connection establishment operations, registration procedure, handover operations, radio link control operations and Medium access control operations.

In an embodiment, the registration accept message comprises a 5G-GUTI, a registration area for the UE (124), a mobility restrictions for the UE (124), a PDU session status of the UE (124), allowed NSSAI for the UE (124), mapping of the allowed NSSAI for the UE (124), configured NSSAI for a serving PLMN associated with the UE (124), mapping of configured NSSAI for the UE (124), a periodic registration update timer, a LADN information and accepted MICO mode, an IMS Voice over PS session supported indication, an emergency service support indicator, accepted DRX parameters, Network support of Interworking, and a network slicing subscription change indication.

The embodiment herein is to provide a method for registering a UE (124) in a telecommunication network (500). The method includes sending, by the UE (124), a registration request message to a network apparatus (2200). Further, the method includes receiving, by the UE (124), an authentication request from a CMF apparatus (154) through the network apparatus (2200), wherein the CMF apparatus (154) is selected by the network apparatus (2200) upon receiving the registration request message from the UE. Further, the method includes performing, by the UE (124), an authentication process and sending an authentication response message to the CMF apparatus (154) selected by the network apparatus (2200). Further, the method includes sending, by the UE (124), a UE capability response message comprising UE capability to the CMF apparatus (154) through the network apparatus (2200). Further, the method includes receiving, by the UE (124), a security mode command from the CMF apparatus (154) through the network apparatus (2200). Further, the method includes sending, by the UE (124), a security mode complete response to the CMF apparatus (154) through the network apparatus (2200). Further, the method includes receiving, by the UE (124), a registration accept message from the CMF apparatus (154) through the network apparatus (2200).

In an embodiment, the registration request message comprises at least one of a registration type, a SUCI, a 5G-GUTI, a PEI, a last visited TAI, security parameters, requested NSSAI for the UE (124), mapping of NSSAI for the UE (124), radio capability update of the UE (124), MM Core network capability of the UE (124), a PDU session status associated with the UE (124), a list of PDU Sessions to be activated for the UE (124), a follow on request, a MICO mode preference of the UE (124), a requested DRX parameters of the UE (124), a policy container of the UE (124), and a UE context.

In an embodiment, the registration accept message comprises a 5G-GUTI, a registration area for the UE (124), a mobility restrictions for the UE (124), a PDU session status of the UE (124), allowed NSSAI for the UE (124), mapping of the allowed NSSAI for the UE (124), configured NSSAI for a serving PLMN associated with the UE (124), mapping of configured NSSAI for the UE (124), a periodic registration update timer, a LADN information and accepted MICO mode, an IMS Voice over PS session supported indication, an emergency service support indicator, accepted DRX parameters, Network support of Interworking, and a network slicing subscription change indication.

In an embodiment, the network apparatus (2200) is one of a hub (156), a CMD (152), and a switch and act as a single anchor point for all UE messages, and wherein the network apparatus (2200) is one of located at independently in the telecommunication network (500), located in NF at a core network in the telecommunication network (500), and located in a DU at a RAN (126) in the telecommunication network (500).

In an embodiment, the CMF apparatus (154) is a NF apparatus comprising a combination of a RRC node, an AMF node (118), and a SMF node (120) in the telecommunication network (500), and wherein the CMF apparatus (154) handles at least one of all RRC operations, NAS operations, connection establishment operations, registration procedure, handover operations, radio link control operations and Medium access control operations.

The embodiment herein is to provide a method for registering a UE (124) in a telecommunication network (500). The method includes receiving, by a network apparatus (2200), a registration request message from the UE. Further, the method includes selecting, by the network apparatus (2200), a CMF apparatus (154) based on a SIB information. Further, the method includes forwarding, by the network apparatus (2200), the registration request message to the selected CMF apparatus (154). Further, the method includes controlling, by the network apparatus (2200), exchange of messages between the UE (124) and the selected CMF apparatus (154) for registration of the UE (124) in the telecommunication network (500).

In an embodiment, forwarding, by the network apparatus (2200), the registration request message to the selected CMF apparatus (154) includes determining, by the network apparatus (2200), whether the UE (124) is in a connected state; and forwarding, by the network apparatus (2200), the registration request message to the selected CMF apparatus (154) based on a Service based interface (SBI) connection of the UE (124).

In an embodiment, the SIB information comprises at least one of a type of service, a NF identifier (ID), and a cell ID with type of service.

In an embodiment, the registration request message comprises at least one of a registration type, a SUCI, a 5G-GUTI, a PEI, a last visited TAI, security parameters, requested NSSAI for the UE (124), mapping of NSSAI for the UE (124), radio capability update of the UE (124), MM Core network capability of the UE (124), a PDU session status associated with the UE (124), a list of PDU Sessions to be activated for the UE (124), a follow on request, a MICO mode preference of the UE (124), a requested DRX parameters of the UE (124), a policy container of the UE (124), and a UE Context.

In an embodiment, the network apparatus (2200) is one of a hub (156), a CMD (152), and a switch and act as a single anchor point for all UE messages, and wherein the network apparatus (2200) is one of located at independently in the telecommunication network (500), located in NF at a core network in the telecommunication network (500), and located in a DU at a RAN (126) in the telecommunication network (500).

In an embodiment, the CMF apparatus (154) is a NF apparatus comprising a combination of a RRC node, an AMF node (118), and a SMF node (120) in the telecommunication network (500), and wherein the CMF apparatus (154) handles at least one of all RRC operations, NAS operations, connection establishment operations, registration procedure, handover operations, radio link control operations and Medium access control operations.

The embodiment herein is to provide a CMF apparatus (154) for registering a UE (124) in a telecommunication network (500). The CMF apparatus includes a memory (2106); a processor (2102); and a registration controller (2108), communicatively coupled to the memory (2106) and the processor (2102). Further, the registration controller (2108) is configured to receive a registration request from the UE (124) through a network apparatus (2200), wherein the CMF apparatus (154) is selected by the network apparatus (2200) upon receiving a registration request message from the UE (124); send an authentication request message and a UE capability enquiry request message to the UE (124) through the network apparatus (2200); receive an authentication response message and a UE capability response message comprising UE capability from the UE (124) through the network apparatus (2200); send a security mode command to the UE (124) through the network apparatus (2200); receive a security mode complete response from the UE (124) through the network apparatus (2200); and send a registration accept message to the UE (124) through the network apparatus (2200), wherein the CMF apparatus (154) acts as a combination of a RRC node, an AMF node (118), and a SMF node (120) in the telecommunication network (500), and wherein the CMF apparatus (154) handles at least one of all RRC operations, NAS operations, connection establishment operations, registration procedure, handover operations, radio link control operations and Medium access control operations.

The embodiment herein is to provide an UE (124) in a telecommunication network (500). The UE (124) includes a memory (2006); a processor (2002); and a registration controller (2008), communicatively coupled to the memory (2006) and the processor (2008). Further, the registration controller (2008) is configured to send a registration request message to a network apparatus (2200); receive an authentication request from a CMF apparatus (154) through the network apparatus (2200), wherein the CMF apparatus (154) is selected by the network apparatus (2200) upon receiving the registration request message from the UE (124); perform an authentication process and sending an authentication response message CMF apparatus (154) selected by the network apparatus (2200); send a UE capability response message comprising UE capability to the CMF apparatus (154) through the network apparatus (2200); receive a security mode command from the CMF apparatus (154) through the network apparatus (2200); send a security mode complete response to the CMF apparatus (154) through the network apparatus (2200); and receive a registration accept message from the CMF apparatus (154) through the network apparatus (2200).

The embodiment herein is to provide a network apparatus (2200) for registering a UE (124) in a telecommunication network (500). The network apparatus (2200) includes a memory (2206); a processor (2202); and a registration controller (2208), communicatively coupled to the memory (2206) and the processor (2202). Further, the registration controller (2202) is configured to receive a registration request message from the UE (124); select a CMF apparatus (154) based on a SIB information; forward the registration request message to the selected CMF apparatus (154); and control exchange of messages between the UE (124) and the selected CMF apparatus (154) for registration of the UE (124) in the telecommunication network (500), wherein the network apparatus (2200) is one of a hub (156), a CMD (152), and a switch and act as a single anchor point for all UE messages, and wherein the network apparatus (2200) is one of located at independently in the telecommunication network (500), located in NF at a core network in the telecommunication network (500), and located in a DU at a RAN (126) in the telecommunication network (500).

The embodiment herein is to provide a method for handling handover in a telecommunication network (500). The method includes receiving, by a source gNB-DU, a measurement report from a UE (124) in the telecommunication network (500); sending, by the source gNB-DU, a RRC message including the measurement report received from the UE (124) to a source CMF apparatus (154a); receiving, by the source gNB-DU, a RRC Reconfiguration message indicating handover requirement from the source CMF apparatus (154a); and sending by the source gNB-DU, the RRC Reconfiguration message to the UE (124) for initiating the handover.

In an embodiment, receiving, by the source gNB-DU, the RRC Reconfiguration message indicating the handover requirement from the source CMF apparatus (154a) includes receiving, by the source gNB-DU, a UE context modification request message comprising the RRC Reconfiguration message from the source CMF apparatus (154a); and sending, by the source gNB-DU, a UE context modification response message to the source CMF apparatus (154a) indicating that the RRC Reconfiguration message is sent to the UE (124).

In an embodiment, the RRC message is a UL RRC transfer message.

In an embodiment, exchange of messages between the UE (124) and the source CMF apparatus (154a) is controlled through a network apparatus (2200), wherein the network apparatus (2200) is one of a hub (156), a CMD (152), and a switch and act as a single anchor point for all UE messages, and wherein the network apparatus (2200) is one of located at independently in the telecommunication network (500), located in a NF at a core network in the telecommunication network (500), and located in a DU at a RAN in the telecommunication network (500).

In an embodiment, the source CMF apparatus (154a) is a NF apparatus comprising a combination of a RRC node, an AMF node (118), and a SMF node (120) in the telecommunication network (500), and wherein the source CMF apparatus (154a) handles at least one of all RRC operations, NAS operations, connection establishment operations, registration procedure, handover operations, radio link control operations and Medium access control operations.

The embodiment herein is to provide a method for handling handover in a telecommunication network (500). The method includes receiving, by a source CMF apparatus (154a), a RRC message including a measurement report received from a UE (124) from a source gNB-DU; determining by the source CMF apparatus (154a), whether the handover is required for the UE (124) based on the received measurement report of the UE; sending, by the source CMF apparatus (154a), a RRC Reconfiguration message indicating handover requirement to the source gNB-DU when the source CMF apparatus (154a) determines that the handover is required for the UE (124).

In an embodiment, sending, by the source CMF apparatus (154a), the RRC Reconfiguration message indicating the handover requirement to the source gNB-DU includes sending, by the source CMF apparatus (154a), a UE context modification request message comprising the RRC Reconfiguration message to the source gNB-DU; and receiving, by the source CMF apparatus (154a), a UE context modification response message from the source gNB-DU indicating that the RRC Reconfiguration message is sent to the UE (124).

In an embodiment, sending, by the source CMF apparatus (154a), the UE context modification request message comprising the RRC Reconfiguration message to the source gNB-DU includes sending, by the source CMF apparatus (154a), a UE context setup request to an eSMF (120a); receiving, by the source CMF apparatus (154a), a UE context setup response from the eSMF (120a) based on the UE context setup request message; and sending, by the source CMF apparatus (154a), the UE context modification request message comprising the RRC Reconfiguration message to the source gNB-DU based on the UE context setup response.

In an embodiment, the RRC message is a UL RRC transfer message.

In an embodiment, exchange of messages between the UE (124) and the source CMF apparatus (154a) is controlled through a network apparatus (2200), wherein the network apparatus (2200) is one of a hub (156), a CMD (152), and a switch and act as a single anchor point for all UE messages, and wherein the network apparatus (2200) is one of located at independently in the telecommunication network (500), located in NF at a core network in the telecommunication network (500), and located in a Distributed Unit (DU) at a Radio Access Network (RAN) in the telecommunication network (500).

In an embodiment, the source CMF apparatus (154a) is a NF apparatus comprising a combination of a RRC node, an AMF node (118), and a SMF node (120) in the telecommunication network (500), and wherein the source CMF apparatus (154a) handles at least one of all RRC operations, NAS operations, connection establishment operations, registration procedure, handover operations, radio link control operations and Medium access control operations.

The embodiment herein is to provide a source gNB (158a) for handling handover in a telecommunication network (500). The method includes a memory (2306); a processor (2302); a handover controller (2308), communicatively coupled to the memory (2306), the processor (2302). Further the handover controller (2308) is configured to receive a measurement report from a UE (124) in the telecommunication network (500); send a RRC message including the measurement report received from the UE (124) to a source CMF apparatus (154a); receive a RRC Reconfiguration message indicating handover requirement from the source CMF apparatus (154a); and send the RRC Reconfiguration message to the UE (124) for initiating the handover.

The embodiment herein is to provide a source CMF apparatus (154a) for handling handover in a telecommunication network (500). The source CMF apparatus (154a) includes a memory (2106); a processor (2102); and a handover controller (2110), communicatively coupled to the memory, and the processor. Further, the handover controller (2110) is configured to receive a RRC message including a measurement report received from a UE (124) from a source gNB-DU; determine whether the handover is required for the UE (124) based on the received measurement report of the UE; send a RRC Reconfiguration message indicating handover requirement to the source gNB-DU when the source CMF apparatus (154a) determines that the handover is required for the UE (124).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. An UE (124) in a telecommunication network (500), comprising:
a memory (2006);
a processor (2002); and
a registration controller (2008), communicatively coupled to the memory (2006) and the processor (2008), wherein the registration controller (2008) is configured to:
send a registration request message to a network apparatus (2200);
receive an authentication request from a CMF apparatus (154) through the network apparatus (2200), wherein the CMF apparatus (154) is selected by the network apparatus (2200) upon receiving the registration request message from the UE (124);
perform an authentication process and send an authentication response message CMF apparatus (154) selected by the network apparatus (2200);
send a UE capability response message comprising UE capability to the CMF apparatus (154) through the network apparatus (2200);
receive a security mode command from the CMF apparatus (154) through the network apparatus (2200);
send a security mode complete response to the CMF apparatus (154) through the network apparatus (2200); and
receive a registration accept message from the CMF apparatus (154) through the network apparatus (2200).

2. The UE (124) as claimed in claim 1, wherein the registration request message comprises at least one of a registration type, a SUCI, a 5G-GUTI, a PEI, a last visited TAI, security parameters, requested NSSAI for the UE (124), mapping of NSSAI for the UE (124), radio capability update of the UE (124), MM Core network capability of the UE (124), a PDU session status associated with the UE (124), a list of PDU Sessions to be activated for the UE (124), a follow on request, a MICO mode preference of the UE (124), a requested DRX parameters of the UE (124), a policy container of the UE (124), or a UE context.

3. The UE (124) as claimed in claim 1, wherein the registration accept message comprises at least one of a 5G-GUTI, a registration area for the UE (124), a mobility restrictions for the UE (124), a PDU session status of the UE (124), allowed NSSAI for the UE (124), mapping of the allowed NSSAI for the UE (124), configured NSSAI for a serving PLMN associated with the UE (124), mapping of configured NSSAI for the UE (124), a periodic registration update timer, a LADN information and accepted MICO mode, an IMS Voice over PS session supported indication, an emergency service support indicator, accepted DRX parameters, Network support of Interworking, or a network slicing subscription change indication.

4. The UE (124) as claimed in claim 1, wherein the network apparatus (2200) is one of a hub (156), a CMD (152), and a switch and act as a single anchor point for all UE messages, and wherein the network apparatus (2200) is one of located at independently in the telecommunication network (500), located in NF at a core network in the telecommunication network (500), and located in a DU at a RAN (126) in the telecommunication network (500).

5. A network apparatus (2200) for registering a UE (124) in a telecommunication network (500), comprising:
a memory (2206);
a processor (2202); and
a registration controller (2208), communicatively coupled to the memory (2206) and the processor (2202), wherein the registration controller (2202) is configured to:
receive a registration request message from the UE (124);
select a CMF apparatus (154) based on a SIB information;
forward the registration request message to the selected CMF apparatus (154); and
control exchange of messages between the UE (124) and the selected CMF apparatus (154) for registration of the UE (124) in the telecommunication network (500).

6. The network apparatus (2200) as claimed in claim 5, wherein the registration controller (2202) is further configured to:
determine whether the UE (124) is in a connected state; and
forward the registration request message to the selected CMF apparatus (154) based on a Service based interface (SBI) connection of the UE (124).

7. The network apparatus (2200) as claimed in claim 5, wherein the SIB information comprises at least one of a type of service, a NF identifier (ID), and a cell ID with type of service.

8. The network apparatus (2200) as claimed in claim 5, wherein the network apparatus (2200) is one of a hub (156), a CMD (152), and a switch and act as a single anchor point for all UE messages, and wherein the network apparatus (2200) is one of located at independently in the telecommunication network (500), located in NF at a core network in the telecommunication network (500), and located in a DU at a RAN (126) in the telecommunication network (500).

9. A source gNB (158a) for handling handover in a telecommunication network (500), comprising:
a memory (2306);
a processor (2302);
a handover controller (2308), communicatively coupled to the memory (2306), the processor (2302), wherein the handover controller (2308) is configured to:
receive a measurement report from a UE (124) in the telecommunication network (500);
send a RRC message including the measurement report received from the UE (124) to a source CMF apparatus (154a);
receive a RRC Reconfiguration message indicating handover requirement from the source CMF apparatus (154a); and
send the RRC Reconfiguration message to the UE (124) for initiating the handover.

10. The source gNB (158a) as claimed in claim 9, wherein the handover controller (2308) is further configured to:
receive a UE context modification request message comprising the RRC Reconfiguration message from the source CMF apparatus (154a); and
sende a UE context modification response message to the source CMF apparatus (154a) indicating that the RRC Reconfiguration message is sent to the UE (124).

11. The source gNB (158a) as claimed in claim 9, wherein the RRC message is a UL RRC transfer message.

12. The source gNB (158a) as claimed in claim 9, wherein exchange of messages between the UE (124) and the source CMF apparatus (154a) is controlled through a network apparatus (2200), wherein the network apparatus (2200) is one of a hub (156), a CMD (152), and a switch and act as a single anchor point for all UE messages, and wherein the network apparatus (2200) is one of located at independently in the telecommunication network (500), located in a NF at a core network in the telecommunication network (500), and located in a DU at a RAN in the telecommunication network (500).

13. A source CMF apparatus (154a) for handling handover in a telecommunication network (500), comprising:
a memory (2106);
a processor (2102); and
a handover controller (2110), communicatively coupled to the memory, and the processor, wherein the handover controller (2110) is configured to:
receive a RRC message including a measurement report received from a UE (124) from a source gNB-DU;
determine whether the handover is required for the UE (124) based on the received measurement report of the UE;
send a RRC Reconfiguration message indicating handover requirement to the source gNB-DU when the source CMF apparatus (154a) determines that the handover is required for the UE (124).

14. The source CMF apparatus (154a) as claimed in claim 13, wherein the handover controller (2110) is further configured to:
send a UE context modification request message comprising the RRC Reconfiguration message to the source gNB-DU; and
receive a UE context modification response message from the source gNB-DU indicating that the RRC Reconfiguration message is sent to the UE (124).

15. The source CMF apparatus (154a) as claimed in claim 14, wherein the handover controller (2110) is further configured to:
send a UE context setup request to an eSMF (120a);
receive a UE context setup response from the eSMF (120a) based on the UE context setup request message; and
send the UE context modification request message comprising the RRC Reconfiguration message to the source gNB-DU based on the UE context setup response.
